(19) United States
(12) Patent Application Publication
(10) Pub. No.: US 2026/0052533 A1
(43) Pub. Date: Feb. 19, 2026

(54) TECHNIQUES FOR CONVEYING CHANNEL INFORMATION TO A NETWORK ENTITY DURING SMALL DATA TRANSMISSION (SDT) OPERATIONS

(71) Applicant: QUALCOMM Incorporated, San Diego, CA (US)

(72) Inventors: Nazmul ISLAM, Littleton, MA (US); Jing LEI, San Diego, CA (US); Raghuveer Ramakrishna Srinivas TARIMALA, Hyderabad (IN); Sai Laxman SAMBARAJU, Hyderabad (IN)

(21) Appl. No.: 18/802,929

(22) Filed: Aug. 13, 2024

(51) Int. Cl. H04W 72/21; H04L 1/00; H04W 72/543; H04W 74/0833

(52) U.S. Cl. CPC H04W 72/21; H04L 1/0003; H04W 72/543; H04W 74/0833

(57) ABSTRACT

Methods, systems, and devices for wireless communications are described. In some cases, a user equipment (UE), in an inactive mode, may initiate a small data transmission (SDT) session based on a size of an uplink payload being less than a threshold size and based on an initial channel quality associated with a communication link between the UE and a network entity satisfying (e.g., meeting or exceeding) a threshold channel quality. In such cases, the UE may transmit, during the SDT session while in the inactive mode, an uplink message indicative of current channel information associated with the UE. Additionally, the UE may receive a control message indicative of one or more communication parameters associated with the UE, where the one or more communication parameters are based on the current channel information associated with the UE.

### TECHNICAL FIELD

The following relates to wireless communications, including techniques for conveying channel information to a network entity during small data transmission (SDT) operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications at a UE in an inactive mode by an apparatus is described. The method may include initiating a transmission session based on a size of an uplink payload being less than a threshold size and based on an initial channel quality associated with a communication link between the UE and a network entity satisfying a threshold channel quality, transmitting, during the transmission session while in the inactive mode, an uplink message indicative of current channel information associated with the UE, and receiving a control message indicative of one or more communication parameters associated with the UE based on transmitting the uplink message indicative of the current channel information associated with the UE.

A UE in an inactive mode is described. The apparatus may include one or more memories storing processor executable code, and one or more processors coupled with the one or more memories. The one or more processors may individually or collectively be operable to execute the code to cause the apparatus to initiate a transmission session based on a size of an uplink payload being less than a threshold size and based on an initial channel quality associated with a communication link between the UE and a network entity satisfying a threshold channel quality, transmit, during the transmission session while in the inactive mode, an uplink message indicative of current channel information associated with the UE, and receive a control message indicative of one or more communication parameters associated with the UE based on transmitting the uplink message indicative of the current channel information associated with the UE.

Another UE in an inactive mode is described. The apparatus may include means for initiating a transmission session based on a size of an uplink payload being less than a threshold size and based on an initial channel quality associated with a communication link between the UE and a network entity satisfying a threshold channel quality, means for transmitting, during the transmission session while in the inactive mode, an uplink message indicative of current channel information associated with the UE, and means for receiving a control message indicative of one or more communication parameters associated with the UE based on transmitting the uplink message indicative of the current channel information associated with the UE.

A non-transitory computer-readable medium storing code for wireless communications at a UE in an inactive mode is described. The code may include instructions executable by one or more processors to initiate a transmission session based on a size of an uplink payload being less than a threshold size and based on an initial channel quality associated with a communication link between the UE and a network entity satisfying a threshold channel quality, transmit, during the transmission session while in the inactive mode, an uplink message indicative of current channel information associated with the UE, and receive a control message indicative of one or more communication parameters associated with the UE based on transmitting the uplink message indicative of the current channel information associated with the UE.

In some examples of the method, UEs, and non-transitory computer-readable medium described herein, the one or more communication parameters may be based on the current channel information associated with the UE.

In some examples of the method, UEs, and non-transitory computer-readable medium described herein, transmitting the uplink message indicative of the current channel information associated with the UE may include operations, features, means, or instructions for transmitting, during an establishment portion of the transmission session, an indication of the initial channel quality associated with the communication link between the UE and the network entity, where the current channel information includes the initial channel quality.

In some examples of the method, UEs, and non-transitory computer-readable medium described herein, transmitting the indication of the initial channel quality may include operations, features, means, or instructions for transmitting a differential value with respect to the threshold channel quality to indicate the initial channel quality.

In some examples of the method, UEs, and non-transitory computer-readable medium described herein, the uplink message may be a third uplink message of a four step RA procedure and the establishment portion of the transmission session includes the four step RA procedure.

In some examples of the method, UEs, and non-transitory computer-readable medium described herein, transmitting the uplink message indicative of the current channel information associated with the UE may include operations, features, means, or instructions for transmitting, during an establishment portion of the transmission session, the uplink message including an indication of whether the initial channel quality associated with the communication link between the UE and the network entity may be within a threshold deviation of a previous channel quality associated with a previous transmission session or reported during a connected mode, where the current channel information includes the indication.

In some examples of the method, UEs, and non-transitory computer-readable medium described herein, transmitting the uplink message may include operations, features, means, or instructions for transmitting the uplink message including the indication that the initial channel quality may be within the threshold of the previous channel quality based on the initial channel quality being within the threshold deviation of the previous channel quality.

Some examples of the method, UEs, and non-transitory computer-readable medium described herein may further include operations, features, means, or instructions for receiving a second control message indicative of the threshold deviation.

In some examples of the method, UEs, and non-transitory computer-readable medium described herein, transmitting the uplink message may include operations, features, means, or instructions for transmitting the uplink message including the indication that the initial channel quality may be within the threshold of the previous channel quality based on the initial channel quality and the previous channel quality being associated with a same MCS value.

Some examples of the method, UEs, and non-transitory computer-readable medium described herein may further include operations, features, means, or instructions for receiving a second control message indicative of a set of multiple mappings between a set of multiple MCS values and a set of multiple channel qualities, where the UE determines the initial channel quality and the previous channel quality may be associated with the same MCS value based on the set of multiple mappings.

In some examples of the method, UEs, and non-transitory computer-readable medium described herein, the UE may be preconfigured with a set of multiple mappings between a set of multiple MCS values and a set of multiple channel qualities and the UE determines the initial channel quality and the previous channel quality may be associated with the same MCS value based on the set of multiple mappings.

In some examples of the method, UEs, and non-transitory computer-readable medium described herein, transmitting the indication of whether the initial channel may be within the threshold deviation of the previous channel quality may include operations, features, means, or instructions for transmitting, via one or more first fields, the indication that the initial channel quality may be within the threshold deviation of the previous channel quality and transmitting, via one or more second fields different than the one or more first fields, the indication that the initial channel quality may be outside of the threshold deviation of the previous channel quality.

In some examples of the method, UEs, and non-transitory computer-readable medium described herein, the one or more first fields may be associated with a first set of one or more resources and the one or more second fields may be associated with a second set of one or more resources.

In some examples of the method, UEs, and non-transitory computer-readable medium described herein, the uplink message may be a first uplink message or a third uplink message of a four step RA procedure and the establishment portion of the transmission session includes the four step RA procedure.

In some examples of the method, UEs, and non-transitory computer-readable medium described herein, the current channel information associated with the UE includes an indication of a change in channel quality associated with the communication link between the UE and the network entity.

In some examples of the method, UEs, and non-transitory computer-readable medium described herein, the indication of the change in channel quality associated with the communication link between the UE and the network entity includes one or more channel quality metrics supported by the UE in the inactive mode and the one or more channel quality metrics may be a subset of a set of multiple channel quality metrics supported by the UE in a connected mode.

In some examples of the method, UEs, and non-transitory computer-readable medium described herein, the set of multiple channel quality metrics supported by the UE in the connected mode may be associated with a first quantity of bits and the one or more channel quality metrics supported by the UE in the inactive mode may be associated with a second quantity of bits less than the first quantity of bits.

Some examples of the method, UEs, and non-transitory computer-readable medium described herein may further include operations, features, means, or instructions for receiving a second control message indicative of a periodicity, a format, or both, associated with the uplink message.

In some examples of the method, UEs, and non-transitory computer-readable medium described herein, the second control message may be a RRC message.

In some examples of the method, UEs, and non-transitory computer-readable medium described herein, the one or more communications parameters supported by the UE in the inactive mode may be a subset of a set of multiple communication parameters supported by the UE in a connected mode.

In some examples of the method, UEs, and non-transitory computer-readable medium described herein, the set of multiple communication parameters supported by the UE in the connected mode may be associated with a first table and the one or more communication parameters supported by the UE in the inactive mode may be associated with a second table.

In some examples of the method, UEs, and non-transitory computer-readable medium described herein, the uplink message includes an SR or a BFR and the uplink message may be multiplexed with an uplink control message or an uplink data message.

In some examples of the method, UEs, and non-transitory computer-readable medium described herein, the one or more communication parameters includes an MCS, a waveform, or both.

In some examples of the method, UEs, and non-transitory computer-readable medium described herein, the control message may be a downlink control information message or a medium access control-control element message.

In some examples of the method, UEs, and non-transitory computer-readable medium described herein, the transmission session may be an SDT session.

A method for wireless communications by a network entity is described. The method may include initiating a transmission session with a user equipment based on a size of an uplink payload being less than a threshold size and based on an initial channel quality associated with a communication link between the UE and the network entity satisfying a threshold channel quality, receiving, during the transmission session while the UE is in an inactive mode, an uplink message indicative of current channel information associated with the UE, and transmitting a control message indicative of one or more communication parameters associated with the UE based on receiving the uplink message indicative of the current channel information associated with the UE.

A network entity for wireless communications is described. The network entity may include one or more memories storing processor executable code, and one or more processors coupled with the one or more memories. The one or more processors may individually or collectively be operable to execute the code to cause the network entity to initiate a transmission session with a user equipment based on a size of an uplink payload being less than a threshold size and based on an initial channel quality associated with a communication link between the UE and the network entity satisfying a threshold channel quality, receive, during the transmission session while the UE is in an inactive mode, an uplink message indicative of current channel information associated with the UE, and transmit a control message indicative of one or more communication parameters associated with the UE based on receiving the uplink message indicative of the current channel information associated with the UE.

Another network entity for wireless communications is described. The network entity may include means for initiating a transmission session with a user equipment based on a size of an uplink payload being less than a threshold size and based on an initial channel quality associated with a communication link between the UE and the network entity satisfying a threshold channel quality, means for receiving, during the transmission session while the UE is in an inactive mode, an uplink message indicative of current channel information associated with the UE, and means for transmitting a control message indicative of one or more communication parameters associated with the UE based on receiving the uplink message indicative of the current channel information associated with the UE.

A non-transitory computer-readable medium storing code for wireless communications is described. The code may include instructions executable by one or more processors to initiate a transmission session with a user equipment based on a size of an uplink payload being less than a threshold size and based on an initial channel quality associated with a communication link between the UE and the network entity satisfying a threshold channel quality, receive, during the transmission session while the UE is in an inactive mode, an uplink message indicative of current channel information associated with the UE, and transmit a control message indicative of one or more communication parameters associated with the UE based on receiving the uplink message indicative of the current channel information associated with the UE.

In some examples of the method, network entities, and non-transitory computer-readable medium described herein, the one or more communication parameters may be based on the current channel information associated with the UE.

In some examples of the method, network entities, and non-transitory computer-readable medium described herein, receiving the uplink message indicative of the current channel information associated with the UE may include operations, features, means, or instructions for receiving, during an establishment portion of the transmission session, an indication of the initial channel quality associated with the communication link between the UE and the network entity, where the current channel information includes the initial channel quality.

In some examples of the method, network entities, and non-transitory computer-readable medium described herein, the initial channel quality may be indicated via a differential value with respect to the threshold channel quality.

In some examples of the method, network entities, and non-transitory computer-readable medium described herein, the uplink message may be a third uplink message of a four step RA procedure and the establishment portion of the transmission session includes the four step RA procedure.

In some examples of the method, network entities, and non-transitory computer-readable medium described herein, receiving the uplink message indicative of the current channel information associated with the UE may include operations, features, means, or instructions for receiving, during an establishment portion of the transmission session, the uplink message including an indication of whether the initial channel quality associated with the communication link between the UE and the network entity may be within a threshold deviation of a previous channel quality associated with a previous transmission session or reported during a connected mode, where the current channel information includes the indication.

In some examples of the method, network entities, and non-transitory computer-readable medium described herein, receiving, the uplink message may include operations, features, means, or instructions for receiving the uplink message including the indication that the initial channel quality may be within the threshold of the previous channel quality based on the initial channel quality being within the threshold deviation of the previous channel quality.

Some examples of the method, network entities, and non-transitory computer-readable medium described herein may further include operations, features, means, or instructions for transmitting a second control message indicative of the threshold deviation.

In some examples of the method, network entities, and non-transitory computer-readable medium described herein, receiving, the uplink message may include operations, features, means, or instructions for receiving the uplink message including the indication that the initial channel quality may be within the threshold of the previous channel quality based on the initial channel quality and the previous channel quality being associated with a same MCS value.

Some examples of the method, network entities, and non-transitory computer-readable medium described herein may further include operations, features, means, or instructions for transmitting a second control message indicative of a set of multiple mappings between a set of multiple MCS values and a set of multiple channel qualities, where the UE determines the initial channel quality and the previous channel quality may be associated with the same MCS value based on the set of multiple mappings.

In some examples of the method, network entities, and non-transitory computer-readable medium described herein, receiving the indication of whether the initial channel may be within the threshold deviation of the previous channel quality may include operations, features, means, or instructions for receiving, via one or more first fields, the indication that the initial channel quality may be within the threshold deviation of the previous channel quality and receiving, via one or more second fields different than the one or more first fields, the indication that the initial channel quality may be outside of the threshold deviation of the previous channel quality.

In some examples of the method, network entities, and non-transitory computer-readable medium described herein, the one or more first fields may be associated with a first set of one or more resources and the one or more second fields may be associated with a second set of one or more resources.

In some examples of the method, network entities, and non-transitory computer-readable medium described herein, the uplink message may be a first uplink message or a third uplink message of a four step RA procedure and the establishment portion of the transmission session includes the four step RA procedure.

In some examples of the method, network entities, and non-transitory computer-readable medium described herein, the current channel information associated with the UE includes an indication of a change in channel quality associated with the communication link between the UE and the network entity.

In some examples of the method, network entities, and non-transitory computer-readable medium described herein, the indication of the change in channel quality associated with the communication link between the UE and the network entity includes one or more channel quality metrics configured for the UE in the inactive mode and the one or more channel quality metrics may be a subset of a set of multiple channel quality metrics configured for the UE in a connected mode.

In some examples of the method, network entities, and non-transitory computer-readable medium described herein, the set of multiple channel quality metrics configured for the UE in the connected mode may be associated with a first quantity of bits and the one or more channel quality metrics configured for the UE in the inactive mode may be associated with a second quantity of bits less than the first quantity of bits.

Some examples of the method, network entities, and non-transitory computer-readable medium described herein may further include operations, features, means, or instructions for transmitting a second control message indicative of a periodicity, a format, or both, associated with the uplink message.

In some examples of the method, network entities, and non-transitory computer-readable medium described herein, the second control message may be a RRC message.

In some examples of the method, network entities, and non-transitory computer-readable medium described herein, the one or more communications parameters configured for the UE in the inactive mode may be a subset of a set of multiple communication parameters configured for the UE in a connected mode.

In some examples of the method, network entities, and non-transitory computer-readable medium described herein, the set of multiple communication parameters configured for the UE in the connected mode may be associated with a first table and the one or more communication parameters configured for the UE in the inactive mode may be associated with a second table.

In some examples of the method, network entities, and non-transitory computer-readable medium described herein, the uplink message includes an SR or a BFR and the uplink message may be multiplexed with an uplink control message or an uplink data message.

In some examples of the method, network entities, and non-transitory computer-readable medium described herein, the one or more communication parameters includes an MCS, a waveform, or both.

In some examples of the method, network entities, and non-transitory computer-readable medium described herein, the control message may be a downlink control information message or a medium access control-control element message.

In some examples of the method, network entities, and non-transitory computer-readable medium described herein, the transmission session may be an SDT session.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for conveying channel information to a network entity during small data transmission (SDT) operations in accordance with one or more aspects of the present disclosure.

FIGS. 2A and 2B each show an example of a wireless communications system that supports techniques for conveying channel information to a network entity during SDT operations in accordance with one or more aspects of the present disclosure.

FIG. 3 shows an example of a process flow that supports techniques for conveying channel information to a network entity during SDT operations in accordance with one or more aspects of the present disclosure.

FIGS. 4 and 5 show block diagrams of devices that support techniques for conveying channel information to a network entity during SDT operations in accordance with one or more aspects of the present disclosure.

FIG. 6 shows a block diagram of a communications manager that supports techniques for conveying channel information to a network entity during SDT operations in accordance with one or more aspects of the present disclosure.

FIG. 7 shows a diagram of a system including a device that supports techniques for conveying channel information to a network entity during SDT operations in accordance with one or more aspects of the present disclosure.

FIGS. 8 and 9 show block diagrams of devices that support techniques for conveying channel information to a network entity during SDT operations in accordance with one or more aspects of the present disclosure.

FIG. 10 shows a block diagram of a communications manager that supports techniques for conveying channel information to a network entity during SDT operations in accordance with one or more aspects of the present disclosure.

FIG. 11 shows a diagram of a system including a device that supports techniques for conveying channel information to a network entity during SDT operations in accordance with one or more aspects of the present disclosure.

FIGS. 12 and 13 show flowcharts illustrating methods that support techniques for conveying channel information to a network entity during SDT operations in accordance with one or more aspects of the present disclosure.

### DETAILED DESCRIPTION

In some wireless communications systems, a user equipment (UE) may support small data transmission (SDT) operations in which the UE may perform (e.g., transmit) an SDT while in an inactive mode (e.g., without transitioning to a connected mode). In such cases, the SDT may be an uplink data message with a payload size less than a threshold size. Thus, as part of the SDT operations, the UE may perform a Contention-Based Random Access Channel (RACH)-Based SDT (RA-SDT) or a Configured Grant (CG)-Based SDT (CG-SDT). In the example of RA-SDT, the UE may initiate an RA-SDT based on the payload size of the uplink data message being less than the threshold size and based on a reference signal receive power (RSRP) of one or more synchronization signal blocks (SSBs) measured by the UE exceeding an SDT-RSRP threshold. However, in such cases, a network entity may not be aware of the RSRP measured by the UE (e.g., an initial channel measurement), such that the network entity may assume that the RSRP of the UE exceeds the SDT-RSRP threshold without knowing an actual value of the RSRP of the UE. Thus, to enable multiple UEs (e.g., the UE and one or more additional UEs) to perform RA-SDT, the network entity may configure (e.g., for the UE and one or more additional UEs) a low value for the SDT-RSRP threshold. However, a lower SDT-RSRP threshold may result in UEs with a higher RSRP spending more time and power in RA-SDT (e.g., as compared to a higher SDT-RSRP threshold). Additionally, or alternatively, during RA-SDT or CG-SDT, the network entity may update a modulation and coding scheme (MCS) of the UE based on success or failure of one or more previous downlink or uplink grants (e.g., shared channel (SCH) grant). However, the network entity may not be aware of an update or change in RSRP of the UE, such that the UE may not be able to update the MCS of the UE based on the change in RSRP of the UE (e.g., based on updated channel information of the UE).

Accordingly, techniques described herein enable a UE to transmit a current channel information (e.g., initial channel quality or updated channel quality) to a network entity during SDT operations (e.g., during an establishment portion of an SDT session or during a transmission portion of the SDT session). In some cases, the UE may transmit the current channel information (e.g., initial channel quality, initial RSRP) during the establishment portion of the SDT session (e.g., SDT session establishment). For example, during the establishment portion of an RA-SDT session, the network entity may transmit, in a random access response (RAR) payload of a second message (e.g., Msg2) of the RA procedure, a request bit field (e.g., including 1 bit) requesting a current RSRP of the UE. Thus, the UE may transmit, in a third message of the RA procedure, an indication of the current RSRP (e.g., initial RSRP) in terms of a differential RSRP. That is, the UE may report the indication of the current RSRP as a differential value with respect to an SDT-RSRP threshold (e.g., configured for the UE). Thus, the network entity may transmit a control message indicating an MCS for the UE based on the current RSRP.

Additionally, or alternatively, in some cases, a current (e.g., initial) RSRP of the UE may change by less than a threshold amount (e.g., may not change) from a previous RSRP of the UE associated with a previous RA-SDT session, such that the UE may re-use an MCS associated with the previous RA-SDT session (e.g., configured for the UE based on the previous RA-SDT session). In such cases, during a current RA-SDT session, the UE may transmit, via a first set of fields (e.g., in a first message or a third message of the current RA-SDT session), an indication that a channel of the UE has not changed (e.g., has changed by less than the threshold amount) from the previous RA-SDT session (e.g., based on the current RSRP changing by less than the threshold amount from the previous RSRP, based on the current RSRP enabling the UE to re-use the previous MCS, or both). Conversely, the UE may transmit, via a second set of fields (e.g., in the first message or the third message of the current RA-SDT session), an indication of the current RSRP (e.g., indicating that the channel has changed from the previous RA-SDT) based on the current RSRP changing by more than the threshold amount from the previous RSRP, based on the current RSRP failing to enable the UE to re-use the previous MCS, or both.

Additionally, or alternatively, the UE may transmit an indication of the current channel information (e.g., updated channel quality, a change in channel quality, updated RSRP) during the transmission portion of the SDT session (e.g., after SDT session establishment). For example, in some cases, the network entity may configure the UE to periodically reporting SSB-based (e.g., or idle tracking reference signal (TRS)-based) wideband channel quality information (CQI), RSRP, signal to interference and noise ratio (SINR), or any combination thereof, after SDT session establishment, such that the network entity may update (e.g., adjust) an MCS of the UE during SDT operations. In some examples, the UE may use a first reduced quantity of bits (e.g., as compared to the UE in the connected mode) to report the current channel information (e.g., RSRP and/or SINR) based on a limited set of current channel information values (e.g., as compared to the UE in the connected mode). Similarly, the UE may support a reduced set of MCS values (e.g., as compared to the UE in the connected mode), such that the network entity may use a second reduced quantity of bits (e.g., as compared to the UE is in the connected mode) to configure the MCS for the UE during SDT operations. Additionally, or alternatively, the UE may aperiodically report the current channel information by transmitting a scheduling request (SR) or buffer status report (BSR), where the SR or BSR may be multiplexed with an uplink transmission (e.g., control message or data message).

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for conveying channel information to a network entity during SDT operations.

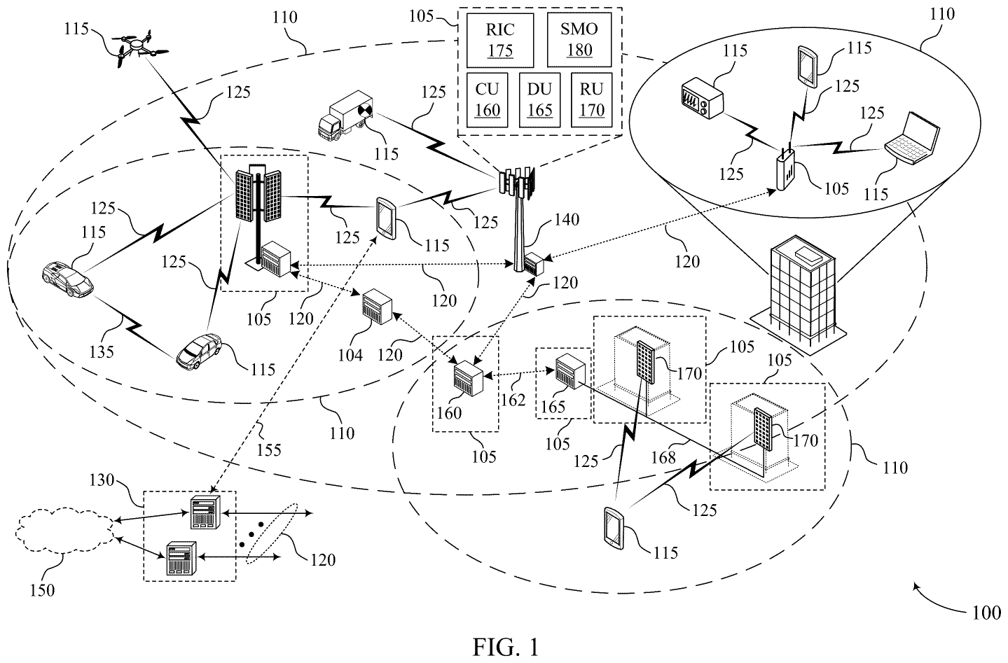

FIG. 1 shows an example of a wireless communications system 100 that supports techniques for conveying channel information to a network entity during SDT operations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or a machine type communication (MTC) device, or the like, which may be implemented in various articles such as appliances, drones, robots, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support one or more random access (RA) procedures. In such cases, a second message (e.g., Msg2) of a RA procedure may include a RAR payload (e.g., RAR grant). In such cases, the RAR payload may include fields according to Table 1 below.

TABLE 1
RAR Contents

| RAR Grant Field | Number of Bits |
|---|---|
| Frequency hopping flag | 1 |
| PUSCH frequency | 12, for operation with |
| resource | shared spectrum channel |
| allocation | access in FR1 or for FR2-2 when |
| | ChannelAccessMode2-r17 is provided |
| | 14, otherwise |
| PUSCH time resource allocation | 4 |
| MCS | 4 |
| Transmit Power Control (TPC) | 3 |
| Command for PUSCH | |
| CSI Request | 1 |
| ChannelAccess-CPext | 2, for operation with |
| | shared spectrum channel |
| | access in FR1 or for FR2-2 when |
| | ChannelAccessMode2-r17 is provided |
| | 0, otherwise |

In some cases (e.g., LTE), the CSI request field (e.g., bit field) may be used to obtain channel knowledge of a UE 115 in Contention Free RA (CFRA), and the CSI request field may be reserved in Contention-Based RA (CBRA). In some other cases (e.g., 5G), the CSI request field may be reserved in both CBRA and CFRA.

In some cases (e.g., 6th Generation (6G), the wireless communications system 100 may support inactive mode operations. For example, SDT may enable a UE 115 to perform short (e.g., less than a threshold) uplink operations, downlink operations, or both, while saving modem power due to not transitioning to a connected mode. Specifically, the SDT may be based on a sensor type of a wireless device (e.g., the UE 115). Additionally, or alternatively, the wireless communications system 100 may support unicast data communications in an inactive mode, in which one or more network entities 105 and one or more UEs 115 may transfer small (e.g., less than a threshold size) packets quickly without entering a connected mode. Additionally, or alternatively, the wireless communications system 100 may support the exchange of channel knowledge between one or more network entities 105 and one or more UEs 115 via system information (e.g., CSI-MeasConfig and SRS-Config type of IEs in SIB1). However, doing so may result in increased signaling overhead.

In some cases, the wireless communications system 100 may support techniques to enable a UE 115 to transmit a current channel information (e.g., initial channel quality or updated channel quality) to a network entity 105 during SDT operations (e.g., during an establishment portion of an SDT session or during a transmission portion of the SDT session). In some cases, the UE 115 may transmit the current channel information (e.g., initial channel quality, initial RSRP) during the establishment portion of the SDT session (e.g., SDT session establishment). For example, during an establishment portion of an RA-SDT session, the network entity 105 may transmit, in a random access response (RAR) payload of a second message (e.g., Msg2) of the RA procedure, a request bit field (e.g., including 1 bit) requesting a current RSRP of the UE 115. Thus, the UE 115 may transmit, in a third message of the RA procedure, an indication of the current RSRP (e.g., initial RSRP) in terms of a differential RSRP. That is, the UE 115 may report the indication of the current RSRP as a differential value with respect to an SDT-RSRP threshold (e.g., configured for the UE 115). Thus, the network entity 105 may transmit a control message indicating a MCS for the UE 115 based on the current RSRP

Additionally, or alternatively, in some cases, a current (e.g., initial) RSRP of the UE 115 may change by less than a threshold amount (e.g., may not change) from a previous RSRP of the UE 115 associated with a previous RA-SDT session, such that the UE 115 may re-use an MCS associated with the previous RA-SDT session (e.g., configured for the UE 115 based on the previous RA-SDT session). In such cases, during a current RA-SDT session, the UE 115 may transmit, via a first set of fields (e.g., in a first message or a third message of the current RA-SDT session), an indication that a channel of the UE 115 has not changed (e.g., has changed by less than the threshold amount) from the previous RA-SDT session based on the current RSRP changing by less than the threshold amount from the previous RSRP, based on the current RSRP enabling the UE 115 to re-use the previous MCS, or both. Conversely, the UE 115 may transmit, via a second set of fields (e.g., in the first message or the third message of the current RA-SDT session), an indication of the current RSRP (e.g., that the channel has changed from the previous RA-SDT) based on the current RSRP changing by more than the threshold amount from the previous RSRP, based on the current RSRP failing to enable the UE 115 to re-use the previous MCS, or both.

Additionally, or alternatively, the UE 115 may transmit an indication of the current channel information (e.g., updated channel quality, a change in channel quality, updated RSRP) during the transmission portion of the SDT session (e.g., after SDT session establishment). For example, in some cases, the network entity 105 may configure the UE 115 to periodically reporting SSB-based (e.g., or idle tracking reference signal (TRS)-based) wideband channel quality information (CQI), RSRP, signal to interference and noise ratio (SINR), or any combination thereof, after SDT session establishment, such that the network entity 105 may update (e.g., adjust) an MCS of the UE 115 during SDT operations. In some examples, the UE 115 may use a first reduced quantity of bits (e.g., as compared to the UE 115 in the connected mode) to report the current channel information (e.g., RSRP and/or SINR) based on a limited set of current channel information values (e.g., as compared to the UE 115 in the connected mode). Similarly, the UE 115 may support a reduced set of MCS values (e.g., as compared to the UE 115 in the connected mode), such that the network entity 105 may use a second reduced quantity of bits (e.g., as compared to the UE 115 is in the connected mode) to configure the MCS for the UE 115 during SDT operations. Additionally, or alternatively, the UE 115 may aperiodically report the current channel information be transmitting a scheduling request (SR) or buffer status report (BSR), where the SR or BSR may be multiplexed with an uplink transmission (e.g., control message or data message).

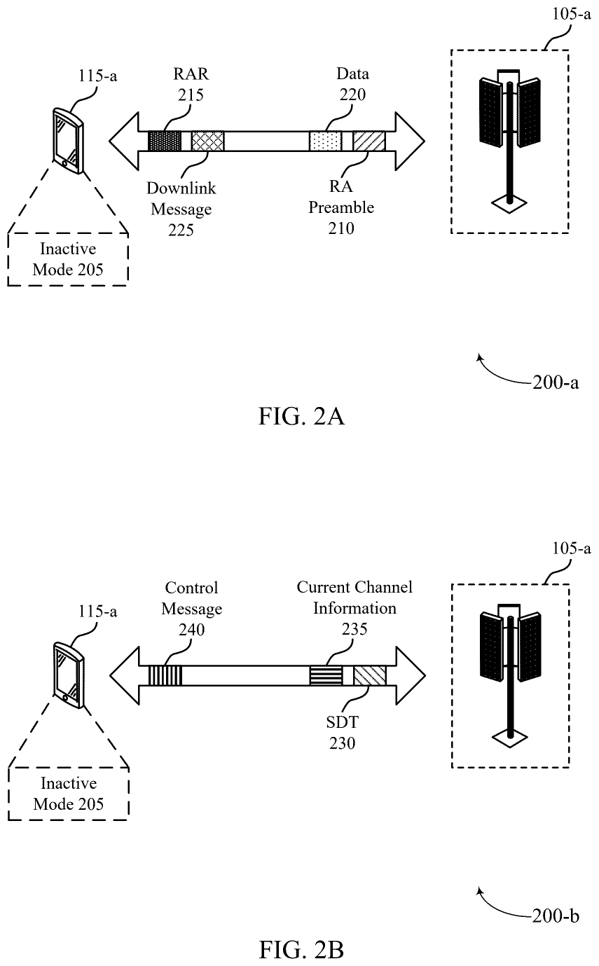

FIGS. 2A and 2B each show an example of a wireless communications system 200 (e.g., a wireless communications system 200-a and a wireless communications system 200-b) that supports techniques for conveying channel information to a network entity during SDT operations in accordance with one or more aspects of the present disclosure. In some cases, the wireless communications systems 200 may implement or be implemented by aspects of the wireless communications system 100. For example, the wireless communications systems 200 may include one or more UEs 115 (e.g., a UE 115-a) and one or more network entities 105 (e.g., a network entity 105-a), which may be examples of the corresponding devices as described herein.

In some wireless communications systems, such as the wireless communications systems 200, a UE 115, such as the UE 115-a, may support SDT operations (e.g., features) in which the UE 115-a may transmit a small uplink message, which may be referred to as an SDT 230, while in an inactive mode 205 (e.g., RRC_INACTIVE state) without transitioning to a connected mode (e.g., RRC_CONNECTED state). In such cases, the SDT 230 may be an uplink message (e.g., uplink data message, uplink control message) with a payload size less than a threshold payload size (e.g., a small payload size). Upon completion of SDT operations (e.g., an SDT), the UE 115-a may remain in the inactive mode or may transition to an idle mode (e.g., RRC_IDLE). Additionally, in some cases, the UE 115-a may fall back to the connected mode during SDT operations (e.g., during an SDT session, during an SDT procedure).

In some examples, the UE 115-a may support at least two types (e.g., methods) of SDT operations (e.g., procedures). A first type of SDT operations may be referred to as RA-SDT (e.g., mobile originated RA-SDT and mobile terminated RA-SDT) and a second type of SDT operations may be referred to as CG-SDT. For RA-SDT operations, the UE 115-a may initiate an RA-SDT session based on a payload size of an uplink payload (e.g., uplink message) to be transmitted by the UE 115-a and based on an RSRP of one or more SSBs (e.g., SSB-RSRP) measured by the UE 115-a. That is, the UE 115-a may initiate the RA-SDT session based on the payload size of the uplink payload being less than a threshold payload size, based on SSB (e.g., Cell Defining SSB (CD-SSB) or Non-Cell Defining SSB (NCD-SSB)) being present in an initial bandwidth part (BWP) associated with the UE 115-a, and based on an RSRP of the SSB, measured by the UE 115-a, meeting or exceeding a threshold RSRP, which may be referred to as an SDT-RSRP threshold.

Thus, according to the RA-SDT operations, the UE 115-a may perform a RA procedure (e.g., 4 step RA procedure) as part of an establishment portion of the SDT session (e.g., to establish the SDT session). For example, the UE 115-a may transmit a first message (e.g., Msg1/MsgA) including a RA preamble 210 and the network entity 105-a may respond to the first message with a second message (e.g., Msg2/MsgB) including a RAR 215 (e.g., RAR payload). Additionally, the UE 115-a may transmit a third message (e.g., Msg3) including data 220 and the network entity may transmit a fourth message (e.g., Msg4, downlink message 225) to support contention resolution. In some examples (e.g., normal SDT operations), the fourth message (e.g., or MsgB) may not carry RRC signaling (e.g., an RRC message), however, in some other examples (e.g., in a case of fallback), the fourth message may include RRC signaling to transition the UE 115-a to the connected mode (e.g., the RRC_CONNECTED state). After the fourth message, the UE 115-a and the network entity 105-a may continue to communicate in accordance with RA-SDT operations (e.g., may continue to communicate during a transmission portion of the SDT session, after SDT session establishment) until the network entity 105-a transmits a control message 240 (e.g., RRC message) or until expiration of a timer (e.g., T319 timer).

During RA-SDT operations, the network entity 105-a may not be aware of an initial channel quality (e.g., current channel information) of the UE 115-a. That is, the network entity 105-a may not be aware of the RSRP measured by the UE 115-a to initiate the RA-SDT session. Thus, the network entity 105-a may assume (e.g., may only assume) that the RSRP measured by the UE 115-a (e.g., initially measured SSB-RSRP) is greater than or equal to the SDT-RSRP threshold (e.g., sdt-rsrp-threshold-r17). As such, the network entity 105-a may configure an MCS (e.g., of an SCH) for the UE 115-a based on the SDT-RSRP threshold and not based on the RSRP measured by the UE 115-a. Thus, to allow for additional UEs 115 to operate according to RA-SDT operations, the network entity 105-a may configure a low value for the SDT-RSRP threshold. However, additional UEs 115 with RSRPs higher (e.g., much higher, a threshold amount higher) than the SDT-RSRP threshold may be configured (e.g., initiated) with a nominal MCS that is based on the SDT-RSRP threshold, such that the additional UEs 115 with the higher RSRPs may spend more time and power than needed operating in accordance with RA-SDT operations (e.g., which is opposite of intended power savings associated with RA-SDT operations).

Additionally, or alternatively, during RA-SDT operations, CG-SDT operations, or both, (e.g., after SDT session establishment) the network entity 105-a may not be aware of a change in channel quality (e.g., an updated channel quality) of the UE 115-a. That is, a current channel quality (e.g., current channel information 235) of the UE 115-a (e.g., during a transmission portion of the SDT session) may be different than the initial channel quality of the UE 115-a (e.g., used to initiate the SDT session). As such, the network entity 105-a may update one or more MCSs of the UE 115-a associated with downlink, uplink, or both, based on success or failure of previous downlink grants (e.g., downlink SCH grants), uplink grants (e.g., uplink SCH grants), or both (e.g., which may be a slow process) but may not update the one or more MCSs of the UE 115-a based on the change in channel quality (e.g., based on the current channel information 235) the UE 115-a due to the network entity 105-a not being aware of the change in channel quality. For example, the network entity 105-a may not (e.g., may not be allowed to) configured the UE 115-a to report CSI (e.g., CSI-MeasConfig) or SRS-related measurements (e.g., SRS-Config) during RA-SDT operations or CG-SDT operations.

Accordingly, techniques described herein may enable a UE 115, such as the UE 115-a, to convey (e.g., report) current channel information 235 (e.g., an initial channel quality or an updated channel quality) to a network entity 105, such as the network entity 105-a, during SDT operations (e.g., during an establishment portion of an SDT session and after establishment of the SDT session).

For example, in some cases, as depicted in FIG. 2A, the UE 115-a may transmit the current channel information to the network entity 105-a during an establishment portion of an SDT session. In such cases, the current channel information may be an initial channel quality, such as initial RSRP, of a communication link (e.g., channel) between the UE 115-a and the network entity 105-a, measured (e.g., obtained) by the UE 115-a to initiate establishment of the SDT session. For example, the UE 115-a may initiate establishment of the SDT session based on a payload size of an uplink payload to be transmitted by the UE 115-a being less than a threshold size and based on the initial RSRP (e.g., of one or more SSBs) measured by the UE 115-a being greater than or equal to an SDT-RSRP threshold (e.g., a threshold RSRP for SDT session initiation). To establish the SDT session, the UE 115-a may transmit a first message (e.g., Msg1/MsgA) including a RA preamble 210 and the network entity 105-a may respond to the first message with a second message (e.g., Msg2/MsgB) including a RAR 215 (e.g., RAR payload). In such cases, the second message may include (e.g., in the RAR payload) a field (e.g., CSI request field) including one or more bits indicating to the UE 115-a whether the UE 115-a is to report the initial channel quality (e.g., current channel information, or knowledge, of the UE 115-a).

For example, in some cases, the field may include (e.g., be set to) 1 bit indicating for the UE 115-a to report the initial channel quality. Thus, the UE 115-a may transmit a third message (e.g., Msg3), responsive to the second message, including an indication of the initial channel quality (e.g., and data 220). As described previously, the initial channel quality may include the initial RSRP measured by the UE 115-a (e.g., to initiate the SDT session, compared to the SDT-RSRP threshold). Thus, the indication of the initial channel quality may be reported in terms of a differential RSRP relative to (e.g., calculated with respect to) the SDT-RSRP threshold. That is, the third message may indicate (e.g., via the RAR payload) a difference between the initial RSRP measured by the UE 115-a and the SDT-RSRP threshold. As such, the network entity 105-a may determine the initial RSRP measured by the UE 115-a (e.g., actual measured SSB-RSRP) based on the differential RSRP (e.g., the difference between the initial RSRP and the SDT-RSRP threshold) and may configured one or more MCSs of the UE 115-a (e.g., SCH MCS) based on the initial RSRP measured by the UE 115-a. In some other cases, the field may include 0 bits indicating for the UE 115-a not to report the initial channel quality. In such cases, the network entity 105-a may configure the one or more MCSs of the UE 115-a (e.g., nominal MCS) based on the SDT-RSRP threshold.

Additionally, or alternatively, the UE 115-a may consider one or more sensors the UE 115-a (e.g., based on one or more sensors) when transmitting transmit the current channel quality to the network entity 105-a during the establishment portion of the SDT session. That is, one or more channels (e.g., the communication link) of the UE 115-a (e.g., RA-SDT UE 115) may not change substantially (e.g., more than a threshold amount) from one RA-SDT session (e.g., procedure, operation) to the next. However, as described herein, the network entity 105-a may configure one or more MCS of the UE 115-a at a beginning of each RA-SDT session. Thus, in some cases, the UE 115-a (e.g., a “static” UE 115) may inform the network entity 105-a that the one or more channels of the UE 115-a did not change (e.g., changed less than the threshold amount) from a last RA-SDT session or from a last connected mode operation (e.g., scenario), such that the network entity 105-a may not (e.g., may not determine to) reconfigure the one or more MCS of the UE 115-a. In other words, the UE 115—may inform the network entity 105-a that the initial RSRP did not change from the last RA-SDT session or from a last RSRP reported during the connected mode prior to the inactive mode.

For example, the UE 115-a may transmit, via the first message, the third message, or both, an indication that the one or more channels of the UE 115-a have not changed (e.g., changed less than the threshold amount) from the last RA-SDT session or from the last reported channel (e.g., RSRP/SINR) during the connected mode. In some cases, the network entity 105-a may configure (e.g., may transmit a control message indicating configuration information for) a first set of RA preambles 210 (e.g., physical random access channel (PRACH) preambles for the first message), a first set of logical channel IDs (LCID) (e.g., for the third message), or both, to be used by the UE 115-a when the one or more channels of the UE 115-a have not changed from the last RA-SDT session or from the last reported channel during the connected mode (e.g., for “static” UEs 115). That is, the UE 115-a may transmit the first message indicating a RA preamble 210 from the first set of RA preambles 210, may transmit the third message indicating an LCID from the first set of LCIDs, or both, to indicate (e.g., implicitly) to the network entity 105-a that the one or more channels of the UE 115-a have not changed from the last RA-SDT session or from the last reported channel during the connected mode (e.g., the last reported RSRP).

In some cases, the UE 115-a may transmit the first message indicating the RA preamble 210 from the first set of RA preambles 210 (e.g., may use the first set of RA preambles 210), may transmit the third message indicating the LCID from the first set of LCIDs (e.g., may use the first set of LCIDs), or both, based on the current channel information (e.g., initial channel quality) associated with the one or more channels failing to exceed (e.g., being less than, satisfying) a threshold deviation with respect to last reported channel information (e.g., last reported channel quality). For example, may transmit the first message indicating the RA preamble 210 from the first set of RA preambles 210, may transmit the third message indicating the LCID from the first set of LCIDs, or both, based on a current RSRP (e.g., current SINR) measured by the UE 115-a satisfying a threshold deviation from a last reported RSRP (e.g., last reported SINR). In some examples, the first set of RA preambles 210 may be reserved on a per-SSB basis. That is, the UE 115-a may use the RA preamble 210 from the first set of RA preambles 210 based on a best SSB not changing (e.g., changing less than the threshold amount) from the connected mode. Thus, the network entity 105-a may assume the current channel information (e.g., RSRP/SINR) of the UE 115-a is within the threshold deviation since the network entity 105-a received the last reported channel information of the UE 115-a. In such cases, the network entity 105-a may transmit control signaling (e.g., system information, RRC signaling) to the UE 115-a indicating the threshold deviation prior to the UE 115-a entering the inactive mode.

Additionally, or alternatively, the UE 115-a may transmit the first message indicating the RA preamble 210 from the first set of RA preambles 210, may transmit the third message indicating the LCID from the first set of LCIDs, or both, based on the current channel information (e.g., current RSRP/current SINR) enabling the network entity 105-a to re-use one or more previous MCSs configured during (e.g., based on) a last SDT session (e.g., RA-SDT operation). For example, in some cases, the network entity 105-a may transmit control signaling indicating a set of mappings between multiple values of the current channel information (e.g., RSRP/SINR) and a set of MCS values (e.g., each value, or range of values, of the multiple values of the current channel information may map to an MCS value from the set of MCS values). In some other cases, the set of mappings may be pre-configured at the UE 115-a. Thus, the UE 115-a may compare the current channel information measured by the UE 115-a to the values of the current channel information associated with the set of mappings and may determine whether the current channel information measured by the UE 115-a maps to an MCS value that is the same as an MCS value used during a most recent RA-SDT session. If so, the UE 115-a may transmit the first message indicating the RA preamble 210 from the first set of RA preambles 210, may transmit the third message indicating the LCID from the first set of LCIDs, or both, to indicate (e.g., implicitly) to the network entity 105-a that the current channel information may enable re-use of the MCS value used during the most recent RA-SDT session.

Transmitting the first message indicating a RA preamble 210 from the first set of RA preambles 210, transmitting the third message indicating the LCID from the first set of LCIDs, or both, may enable the UE 115-a to avoid explicit reporting of current channel information during RA-SDT sessions, but may still enable the network entity 105-a to be aware of the current channel information of the UE 115-a (e.g., from a most recent RA-SDT operation rather than a most recently reported RSRP/SINR during the connected mode).

Additionally, or alternatively, the network entity 105-a may configure (e.g., may transmit a control message indicating configuration information for) a second set of RA preambles 210 (e.g., PRACH preambles for the first message), a second set of LCIDs (e.g., for the third message), or both, to be used by the UE 115-a when the one or more channels of the UE 115-a have changed from the last RA-SDT session or from the last reported channel during the connected mode. That is, if the current channel information (e.g., RSRP/SINR) measured by the UE 115-a exceeds the threshold deviation from the last reported channel information (e.g., last reported RSRP, last reported CQI) or if the current channel information does not map to a same MCS value as an MCS value used during a most recent RA-SDT session (e.g., and if the current channel information exceeds the SDT-RSRP threshold), the UE 115-a may transmit the first message indicating a RA preamble 210 from the second set of RA preambles 210 (e.g., may use the second set of RA preambles 210), may transmit the third message indicating an LCID from the second set of LCIDs (e.g., may use the second set of LCIDs), or both.

In some examples (e.g., 5G RA-SDT), the network entity 105-a may gradually adjust an MCS during an RA-SDT session based on a cyclic redundancy check (CRC) pass or fail, but may restart a following (e.g., next) RA-SDT session with a nominal MCS (e.g., based on sdt-rsrp-r17). Additionally, or alternatively, the one or more sensors of the UE 115-a may be expected (e.g., by the UE 115-a, the network entity 105-a, or both) to remain in the inactive mode for a threshold (e.g., long) duration and to transmit small bursts of uplink traffic intermittently through an SDT session without entering the connected mode.

Additionally, or alternatively, in some cases, as depicted in FIG. 2B, the UE 115-a may transmit the current channel information 235 to the network entity 105-a after the establishment portion of the SDT session. In such cases, the current channel information 235 may be an updated channel quality (e.g., a change in channel quality), such as updated RSRP, measured (e.g., obtained) by the UE 115-a that differs from the initial channel quality measured by the UE 115-a to initiate the SDT session or from other channel qualities previously reported by the UE 115-a during the SDT session. That is, the UE 115-a may measure the initial channel quality to initiate the SDT session (e.g., during which the UE 115-a may perform one or more SDTs 230) and, during the SDT session (e.g., after the establishment portion of the SDT session while still in the inactive mode 205, during a transmission portion of the SDT session), the UE 115-a may transmit an updated channel quality (e.g., current channel information 235) that differs from the initial channel quality.

In some cases, the UE 115-a may re-use a subset of connected mode channel information (e.g., CQI) reporting mechanisms to enable channel information reporting during an SDT session (e.g., procedure, operations). That is, the UE 115-a may support a first set of channel information reporting mechanism in the connected mode and may support a subset of the first set of channel information reporting mechanisms during an SDT session (e.g., in the inactive mode 205). For example, the UE 115-a may support (e.g., only support) SSB-based wideband channel information reporting, tracking reference signal (TRS)-based wideband channel information reporting, or both, during an SDT session. Additionally, or alternatively, the updated channel quality may be reported as RSRP, SINR (e.g., of SSB, TRS, or both), or both, during an SDT session. In such cases, the network entity 105-a may transmit a control message 240 (e.g., system information, RRCRelease w/SuspendConfig transmitted when transitioning the UE 115-a to the inactive mode 205) indicating (e.g., configuring) a periodicity, a format, or both, of the subset of the first set of channel information reporting mechanisms. Thus, the network entity 105-a may adjust an MCS of CGs during the SDT session based on the updated channel quality (e.g., reported CQI or RSRP/SINR).

Additionally, or alternatively, the UE 115-a may support a reduced (e.g., limited) set of updated channel quality values (e.g., RSRP values, SINR values, or both) for updated channel quality reporting (e.g., channel state feedback (CSF) reporting) during the SDT session (e.g., as compared to the UE 115-a in the connected mode), during the inactive mode 205, or both. Thus, the UE 115-a may support reduced signaling overhead to convey the updated channel quality (e.g., current channel information 235) using a smaller quantity of bits and the reduce set of updated channel quality values (e.g., as compared to the UE 115-a in the connected mode). Additionally, or alternatively, the network entity 105-a, the UE 115-a, or both, may support a reduced set of MCS values during the SDT session, during the inactive mode 205, or both (e.g., as compared to the UE 115-a in the connected mode). In some cases, the reduced set of MCS values may be a subset of possible MCS values configured for the UE 115-a during the connected mode. In some other cases, the reduced set of MCS values may be configured (e.g., associated with) via a different MCS table associated with the inactive mode 205 than an MCS table configured for the UE 115-a in the connected mode. In such cases, the different MCS table may include a quantity of repetitions. Thus, the network entity 105-a may support reduced signaling overhead (e.g., less bits as compared to the UE 115-a operating in the connected mode) for indicating an MCS from the reduced set of MCS values during the inactive mode 205 of the UE 115-a. In some examples, the network entity 105-a may transmit an additional control message 240 (e.g., downlink control information (DCI) or medium access control-control element (MAC-CE) to change (e.g., dynamically or semi-statically) an MCS of the UE 115-a (e.g., and/or a waveform of the UE 115-a) during the SDT session.

Additionally, or alternatively, the UE 115-a may report (e.g., aperiodically) the updated channel quality (e.g., CSF) via a scheduling request (SR) or a buffer status report (BSR), where the SR or BFR is multiplexed with an uplink control message, an uplink data message, or both.

Though described in the context of an SDT session this is not to be regarded as a limitation of the present disclosure. In this regard, the term “SDT session” refers to any time during which the UE 115-a is performing SDT operations, including both the establishment portion of an SDT session (e.g., during which a RA procedure is performed) and the transmission portion of the SDT session (e.g., any time after the establishment portion before completion of the SDT session).

Though described in the context of SDT operations (e.g., an SDT 230), this is not to be regarded as a limitation of the present disclosure. In this regard, the term “SDT” simply refers to a data transmission with a payload size less than a threshold size. Additionally, or alternatively, though described in the context of “RA-SDT” and “CG-SDT” this is not to be regarded as a limitation of the present disclosure. In this regard, the techniques described herein may be applicable during a duration of any RACH procedure, post-RACH operation, or both, for UEs 115 in the inactive mode 205 (e.g., until the UEs 115 transition to the connected mode or the idle mode).

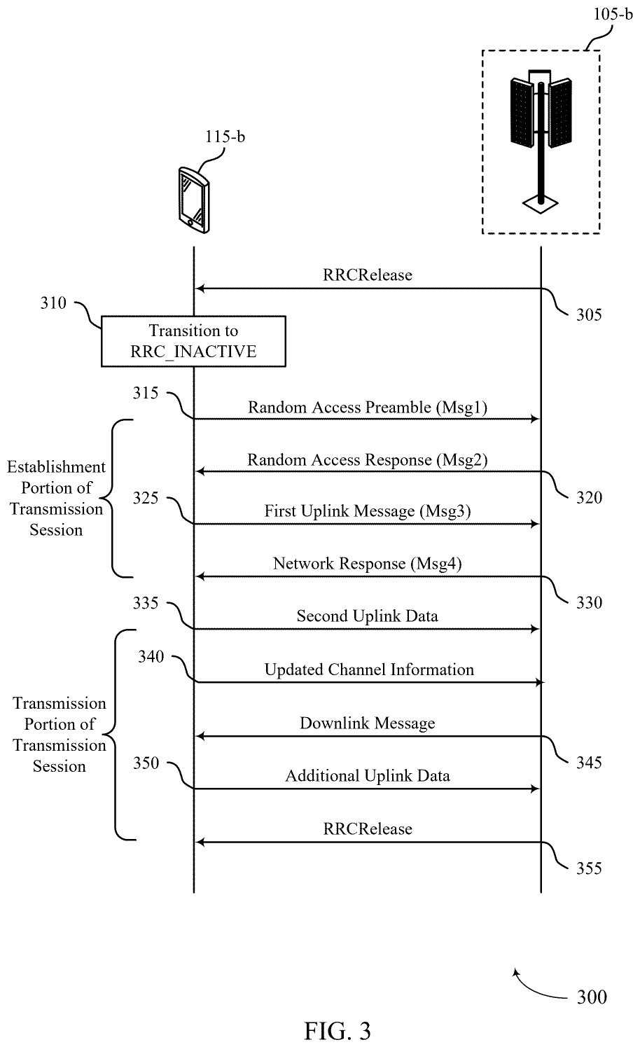

FIG. 3 shows an example of a process flow 300 that supports techniques for conveying channel information to a network entity during SDT operations in accordance with one or more aspects of the present disclosure. In some cases, the process flow 300 may implement or be implemented by aspects of the wireless communications system 100, the wireless communications systems 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the network entity 105-b may transmit a first control message (e.g., RRCRelease w/SuspendConfig) to transition the UE 115-b to an inactive mode (e.g., RRC_INACTIVE). Thus, at 310, the UE 115-b may transition to the inactive mode based on receiving the first control message.

At 315, the UE 115-a may initiate a transmission session (e.g., SDT session) by transmitting, to the network entity 105-b, a first message (e.g., Msg1) of a RA procedure (e.g., 4-step RACH procedure). In such cases, the UE 115-b may initiate the transmission session based on a size of an uplink payload being less than a threshold size and based on an initial channel quality (e.g., initial RSRP) associated with a communication link between the UE 115-b and the network entity 105-b satisfying a threshold channel quality (e.g., SDT-RSRP threshold).

In some cases, the first message (e.g., uplink message) may be indicative of current channel information associated with the communication link, where the current channel information includes the initial channel quality. For example, the first message may indicate whether the initial channel quality associated with the communication link between the UE 115-b and the network entity 105-b is within a threshold deviation of a previous channel quality associated with a previous transmission session or reported during a connected mode. In some cases, the first message may indicate whether the initial channel quality is within the threshold deviation of the previous channel quality based on one or more fields in the first message. For example, a first set of RA preambles may indicate that the initial channel quality is within (e.g., less than or equal to) the threshold deviation of the previous channel quality and a second set of RA preambles may indicate that the initial channel quality is not within (e.g., outside of, exceeds) the threshold deviation of the previous channel quality. Thus, the UE 115-b may transmit the first message indicating a RA preamble from the first set of RA preambles or from the second set of RA preambles based on whether the initial channel quality is within the threshold deviation of the previous channel quality.

In some cases, the UE 115-b may transmit the first message including the indication (e.g., indicating) that the initial channel quality is within the threshold deviation of the previous channel quality based on the initial channel quality being within the threshold deviation of the previous channel quality associated with the previous transmission session or reported during the connected mode. In such cases, the threshold deviation may be indicated to the UE 115-b (e.g., by the network entity 105-b) via a second control message.

Additionally, or alternatively, the UE 115-b may transmit the first message including the indication that the initial channel quality is within the threshold deviation of the previous channel quality based on the initial channel quality and the previous channel quality being associated with a same MCS value. That is, in some cases, the UE 115-b may receive (e.g., prior to transmitting the first message) a third control message indicative of multiple mappings between multiple MCS values and multiple channel qualities, such that the UE 115-b may determine the initial channel quality and the previous channel quality are associated with a same MCS value based on the multiple mappings. In some other cases, the UE 115-b may be preconfigured with the multiple mappings.

At 320, the network entity 105-b may transmit, to the UE 115-b, a second message (e.g., Msg2) of the RA procedure, where the second message includes a RAR (e.g., RAR payload). In some examples, the second message may include a request for the UE 115-b to report the current channel information.

At 325, the UE 115-b may transmit a third message (e.g., Msg3) of the RA procedure. In some cases, the third message may be indicative of the current channel information associated with the communication link between the UE 115-b and the network entity 105-b, where the current channel information includes the initial channel quality. In some examples, the third message (e.g., RAR payload) may indicate the initial channel quality as a differential value with respect to the threshold channel quality. In some other examples, the third message may indicate whether the initial channel quality associated with the communication link between the UE 115-b and the network entity 105-b is within the threshold deviation of the previous channel quality associated with the previous transmission session or reported during the connected mode.

In some cases, the third message may indicate whether the initial channel quality is within the threshold deviation of the previous channel quality based on one or more fields in the third message. For example, a first set of LCIDs may indicate that the initial channel quality is within (e.g., less than or equal to) the threshold deviation of the previous channel quality and a second set of LCIDs may indicate that the initial channel quality is not within (e.g., outside of, exceeds) the threshold deviation of the previous channel quality. Thus, the UE 115-b may transmit the third message indicating an LCID from the first set of LCIDs or from the second set of LCIDs based on whether the initial channel quality is within the threshold deviation of the previous channel quality.

In some cases, the UE 115-b may transmit the third message including the indication that the initial channel quality is within the threshold deviation of the previous channel quality based on the initial channel quality being within the threshold deviation of the previous channel quality associated with the previous transmission session or reported during the connected mode. In such cases, the threshold deviation may be indicated to the UE 115-b (e.g., by the network entity 105-b) via the second control message.

Additionally, or alternatively, the UE 115-b may transmit the third message including the indication that the initial channel quality associated with the communication link is within the threshold deviation of the previous channel quality based on the initial channel quality and the previous channel quality being associated with a same MCS value. That is, in some cases, the UE 115-b may receive (e.g., prior to the third message) the third control message indicative of multiple mappings between multiple MCS values and multiple channel qualities, such that the UE 115-b may determine the initial channel quality and the previous channel quality are associated with a same MCS value based on the multiple mappings. In some other cases, the UE 115-b may be preconfigured with the multiple mappings.

At 330, the network entity 105-b may transmit a fourth message (e.g., Msg4) of the RA procedure. In some examples, the RA procedure (e.g., transmission and reception of the first message, the second message, the third message, and the fourth message) may be associated with an establishment portion of the transmission session.

At 335, the UE 115-b may complete establishment of the transmission session and may transmit an uplink message indicative of the uplink payload (e.g., perform an SDT transmission).

At 340, the UE 115-b may transmit a second uplink message indicate of the current channel information associated with the communication link between the UE 115-b and the network entity 105-b. In such cases, the current channel information may include an indication of a change in channel quality associated with the communication link between the UE 115-b and the network entity 105-b (e.g., relative to the initial channel quality or from another channel quality). That is, the current channel information may indicate a current channel quality that is different that the initial channel quality or a previously reported channel quality. In such cases, the indication of the change in channel quality (e.g., the current channel quality, an updated channel quality) may include one or more channel quality metrics supported by the UE 115-b in the inactive mode, where the one or more channel quality metrics may be a subset of multiple channel quality metrics supported by the UE 115-b in the connected mode. In some examples, the UE 115-b may receive, prior to transmission of the second uplink message, a fourth control message indicative of a periodicity, a format, or both, associated with the second uplink message.

In some cases, the second uplink message may include an SR or a BSR and may be multiplexed with an uplink control message or an uplink data message.

At 345 (e.g., or during the RA procedure), the UE 115-b may receive a downlink message (e.g., a fifth control message) indicative of one or more communication parameters associated with the UE 115-b, where the one or more communication parameters are based on the current channel information associated with the UE 115-b (e.g., the initial channel quality or the change in channel quality). In some examples, the one or more communication parameters supported by the UE 115-b in the inactive mode may be a subset of multiple communication parameters supported by the UE 115-b in the connected mode.

At 350, the UE 115-b may transmit one or more additional uplink messages (e.g., SDTs) during the transmission session.

At 355, the UE 115-b may receive an additional control message (e.g., RRCRelease) indicating for the UE 115-b to transition to a different mode (e.g., connected more or idle mode), where the UE 115-b transitioning out of the inactive mode may end the transmission session.

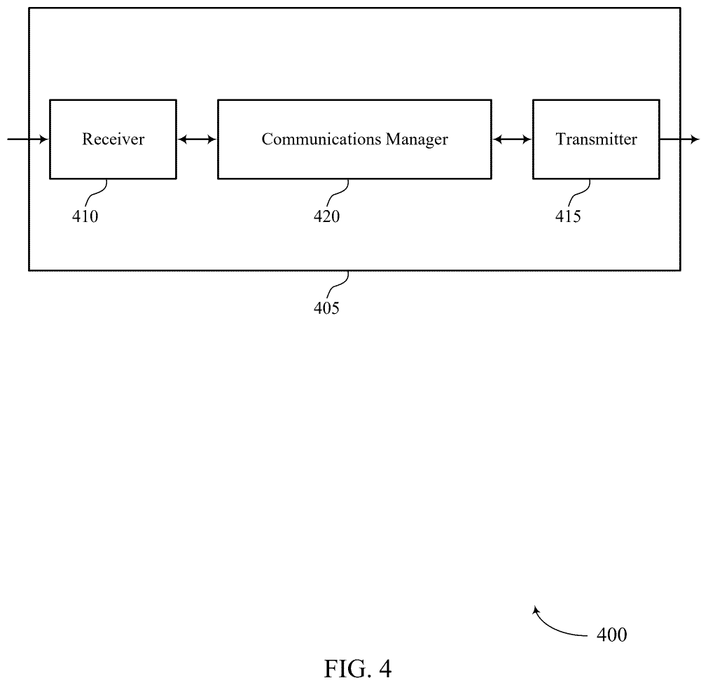

FIG. 4 shows a block diagram 400 of a device 405 that supports techniques for conveying channel information to a network entity during SDT operations in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for conveying channel information to a network entity during SDT operations). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for conveying channel information to a network entity during SDT operations). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for conveying channel information to a network entity during SDT operations as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in an inactive mode in accordance with examples as disclosed herein. For example, the communications manager 420 is capable of, configured to, or operable to support a means for initiating a transmission session based on a size of an uplink payload being less than a threshold size and based on an initial channel quality associated with a communication link between the UE and a network entity satisfying a threshold channel quality. The communications manager 420 is capable of, configured to, or operable to support a means for transmitting, during the transmission session while in the inactive mode, an uplink message indicative of current channel information associated with the UE. The communications manager 420 is capable of, configured to, or operable to support a means for receiving a control message indicative of one or more communication parameters associated with the UE based on transmitting the uplink message indicative of the current channel information associated with the UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for conveying channel information to a network entity during SDT operations, which may result in reduced processing, reduced power consumption, and more efficient utilization of communication resources, among other advantages.

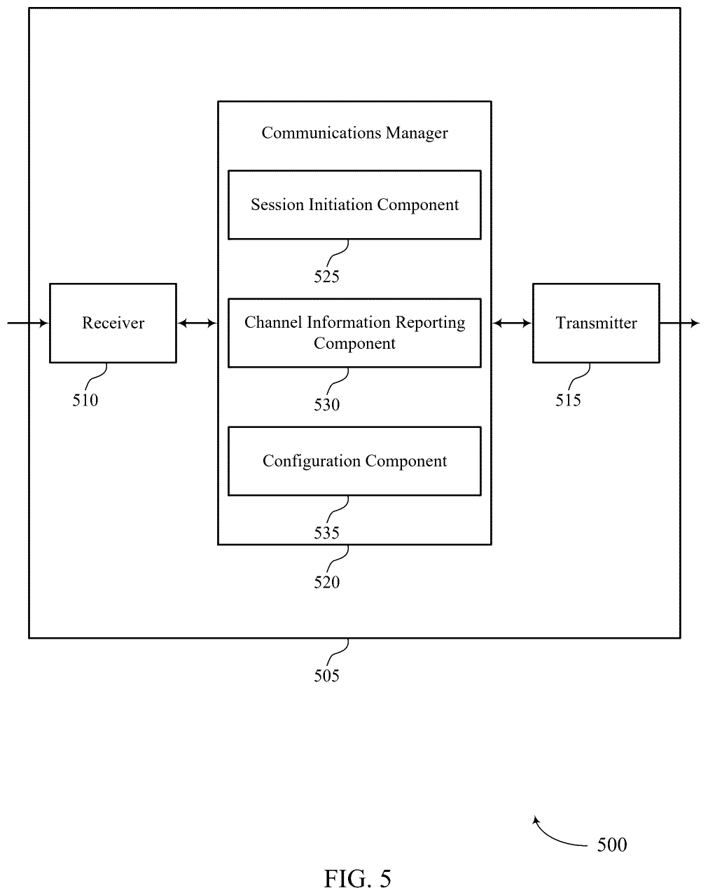

FIG. 5 shows a block diagram 500 of a device 505 that supports techniques for conveying channel information to a network entity during SDT operations in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for conveying channel information to a network entity during SDT operations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for conveying channel information to a network entity during SDT operations). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for conveying channel information to a network entity during SDT operations as described herein. For example, the communications manager 520 may include a session initiation component 525, a channel information reporting component 530, a configuration component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in an inactive mode in accordance with examples as disclosed herein. The session initiation component 525 is capable of, configured to, or operable to support a means for initiating a transmission session based on a size of an uplink payload being less than a threshold size and based on an initial channel quality associated with a communication link between the UE and a network entity satisfying a threshold channel quality. The channel information reporting component 530 is capable of, configured to, or operable to support a means for transmitting, during the transmission session while in the inactive mode, an uplink message indicative of current channel information associated with the UE. The configuration component 535 is capable of, configured to, or operable to support a means for receiving a control message indicative of one or more communication parameters associated with the UE based on transmitting the uplink message indicative of the current channel information associated with the UE.

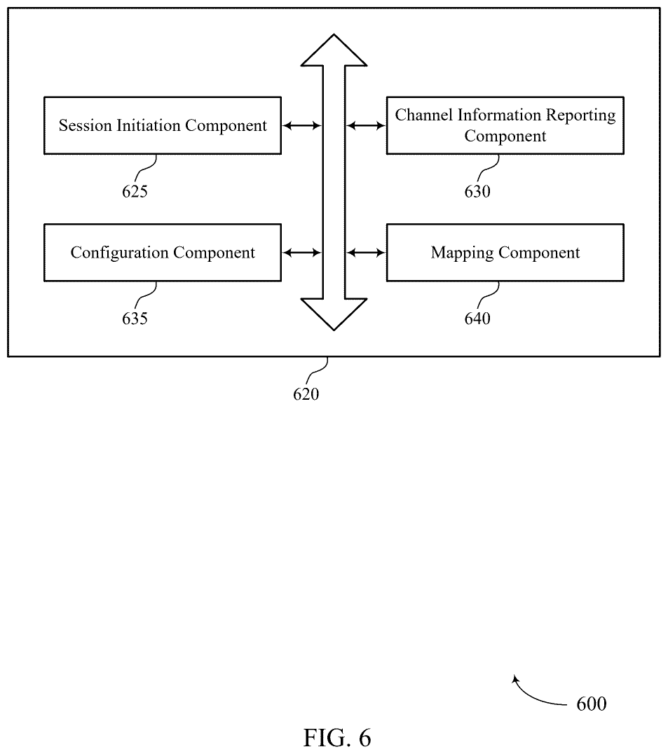

FIG. 6 shows a block diagram 600 of a communications manager 620 that supports techniques for conveying channel information to a network entity during SDT operations in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for conveying channel information to a network entity during SDT operations as described herein. For example, the communications manager 620 may include a session initiation component 625, a channel information reporting component 630, a configuration component 635, a mapping component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications at a UE in an inactive mode in accordance with examples as disclosed herein. The session initiation component 625 is capable of, configured to, or operable to support a means for initiating a transmission session based on a size of an uplink payload being less than a threshold size and based on an initial channel quality associated with a communication link between the UE and a network entity satisfying a threshold channel quality. The channel information reporting component 630 is capable of, configured to, or operable to support a means for transmitting, during the transmission session while in the inactive mode, an uplink message indicative of current channel information associated with the UE. The configuration component 635 is capable of, configured to, or operable to support a means for receiving a control message indicative of one or more communication parameters associated with the UE based on transmitting the uplink message indicative of the current channel information associated with the UE.

In some examples, the one or more communication parameters may be based on the current channel information associated with the UE.

In some examples, to support transmitting the uplink message indicative of the current channel information associated with the UE, the channel information reporting component 630 is capable of, configured to, or operable to support a means for transmitting, during an establishment portion of the transmission session, an indication of the initial channel quality associated with the communication link between the UE and the network entity, where the current channel information includes the initial channel quality.

In some examples, to support transmitting the indication of the initial channel quality, the channel information reporting component 630 is capable of, configured to, or operable to support a means for transmitting a differential value with respect to the threshold channel quality to indicate the initial channel quality.

In some examples, the uplink message is a third uplink message of a four step RA procedure. In some examples, the establishment portion of the transmission session includes the four step RA procedure.

In some examples, to support transmitting the uplink message indicative of the current channel information associated with the UE, the channel information reporting component 630 is capable of, configured to, or operable to support a means for transmitting, during an establishment portion of the transmission session, the uplink message including an indication of whether the initial channel quality associated with the communication link between the UE and the network entity is within a threshold deviation of a previous channel quality associated with a previous transmission session or reported during a connected mode, where the current channel information includes the indication.

In some examples, to support transmitting the uplink message, the channel information reporting component 630 is capable of, configured to, or operable to support a means for transmitting the uplink message including the indication that the initial channel quality is within the threshold of the previous channel quality based on the initial channel quality being within the threshold deviation of the previous channel quality.

In some examples, the configuration component 635 is capable of, configured to, or operable to support a means for receiving a second control message indicative of the threshold deviation.

In some examples, to support transmitting the uplink message, the channel information reporting component 630 is capable of, configured to, or operable to support a means for transmitting the uplink message including the indication that the initial channel quality is within the threshold of the previous channel quality based on the initial channel quality and the previous channel quality being associated with a same MCS value.

In some examples, the mapping component 640 is capable of, configured to, or operable to support a means for receiving a second control message indicative of a set of multiple mappings between a set of multiple MCS values and a set of multiple channel qualities, where the UE determines the initial channel quality and the previous channel quality are associated with the same MCS value based on the set of multiple mappings.

In some examples, the UE is preconfigured with a set of multiple mappings between a set of multiple MCS values and a set of multiple channel qualities. In some examples, the UE determines the initial channel quality and the previous channel quality are associated with the same MCS value based on the set of multiple mappings.

In some examples, to support transmitting the indication of whether the initial channel is within the threshold deviation of the previous channel quality, the channel information reporting component 630 is capable of, configured to, or operable to support a means for transmitting, via one or more first fields, the indication that the initial channel quality is within the threshold deviation of the previous channel quality. In some examples, to support transmitting the indication of whether the initial channel is within the threshold deviation of the previous channel quality, the channel information reporting component 630 is capable of, configured to, or operable to support a means for transmitting, via one or more second fields different than the one or more first fields, the indication that the initial channel quality is outside of the threshold deviation of the previous channel quality.

In some examples, the one or more first fields are associated with a first set of one or more resources. In some examples, the one or more second fields are associated with a second set of one or more resources.

In some examples, the uplink message is a first uplink message or a third uplink message of a four step RA procedure. In some examples, the establishment portion of the transmission session includes the four step RA procedure.

In some examples, the current channel information associated with the UE includes an indication of a change in channel quality associated with the communication link between the UE and the network entity.

In some examples, the indication of the change in channel quality associated with the communication link between the UE and the network entity includes one or more channel quality metrics supported by the UE in the inactive mode. In some examples, the one or more channel quality metrics are a subset of a set of multiple channel quality metrics supported by the UE in a connected mode.

In some examples, the set of multiple channel quality metrics supported by the UE in the connected mode are associated with a first quantity of bits. In some examples, the one or more channel quality metrics supported by the UE in the inactive mode are associated with a second quantity of bits less than the first quantity of bits.

In some examples, the configuration component 635 is capable of, configured to, or operable to support a means for receiving a second control message indicative of a periodicity, a format, or both, associated with the uplink message.

In some examples, the second control message is an RRC message.

In some examples, the one or more communications parameters supported by the UE in the inactive mode are a subset of a set of multiple communication parameters supported by the UE in a connected mode.

In some examples, the set of multiple communication parameters supported by the UE in the connected mode are associated with a first table. In some examples, the one or more communication parameters supported by the UE in the inactive mode are associated with a second table.

In some examples, the uplink message includes an SR or a BSR. In some examples, the uplink message is multiplexed with an uplink control message or an uplink data message.

In some examples, the one or more communication parameters includes an MCS, a waveform, or both.

In some examples, the control message is a DCI message or a MAC-CE message.

In some examples, the transmission session is an SDT session.

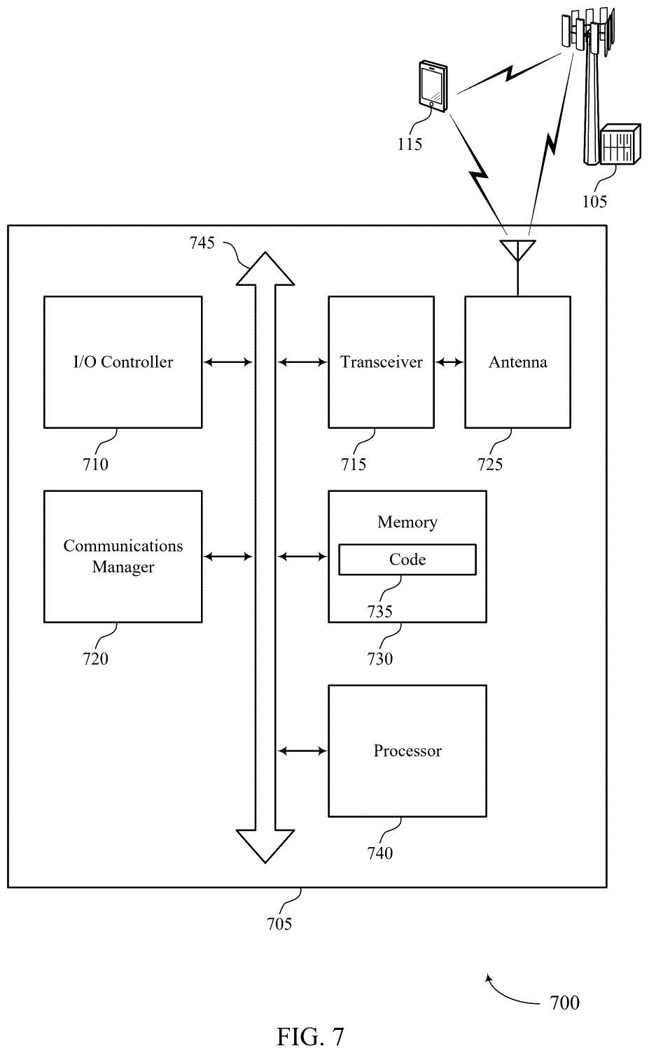

FIG. 7 shows a diagram of a system 700 including a device 705 that supports techniques for conveying channel information to a network entity during SDT operations in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for conveying channel information to a network entity during SDT operations). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications at a UE in an inactive mode in accordance with examples as disclosed herein. For example, the communications manager 720 is capable of, configured to, or operable to support a means for initiating a transmission session based on a size of an uplink payload being less than a threshold size and based on an initial channel quality associated with a communication link between the UE and a network entity satisfying a threshold channel quality. The communications manager 720 is capable of, configured to, or operable to support a means for transmitting, during the transmission session while in the inactive mode, an uplink message indicative of current channel information associated with the UE. The communications manager 720 is capable of, configured to, or operable to support a means for receiving a control message indicative of one or more communication parameters associated with the UE based on transmitting the uplink message indicative of the current channel information associated with the UE.

By including or configuring the communications manager 720 in accordance with examples as described herein, the device 705 may support techniques for conveying channel information to a network entity during SDT operations, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for conveying channel information to a network entity during SDT operations as described herein, or the at least one processor 740 and the at least one memory 730 may be otherwise configured to, individually or collectively, perform or support such operations.

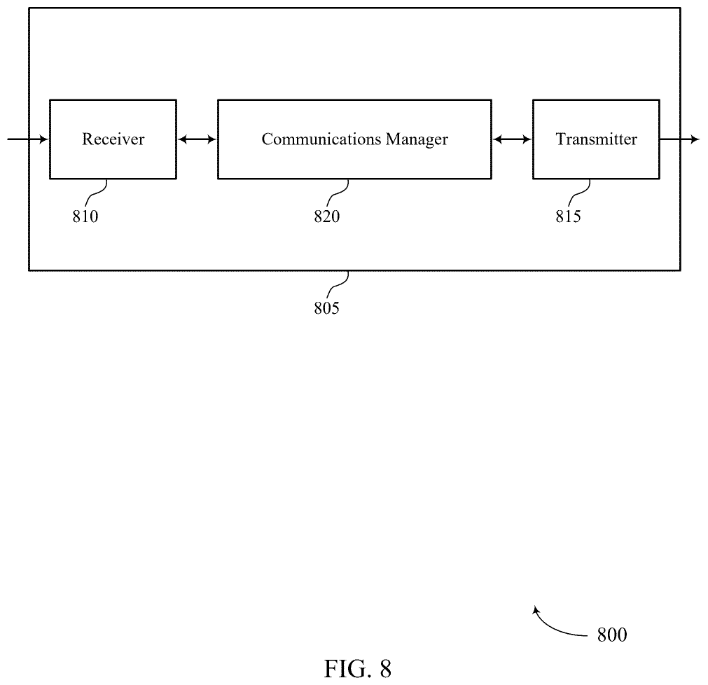

FIG. 8 shows a block diagram 800 of a device 805 that supports techniques for conveying channel information to a network entity during SDT operations in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for conveying channel information to a network entity during SDT operations as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, a GPU, an NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for initiating a transmission session with a user equipment based on a size of an uplink payload being less than a threshold size and based on an initial channel quality associated with a communication link between the UE and the network entity satisfying a threshold channel quality. The communications manager 820 is capable of, configured to, or operable to support a means for receiving, during the transmission session while the UE is in an inactive mode, an uplink message indicative of current channel information associated with the UE. The communications manager 820 is capable of, configured to, or operable to support a means for transmitting a control message indicative of one or more communication parameters associated with the UE based on receiving the uplink message indicative of the current channel information associated with the UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for conveying channel information to a network entity during SDT operations, which may result in reduced processing, reduced power consumption, and more efficient utilization of communication resources, among other advantages.

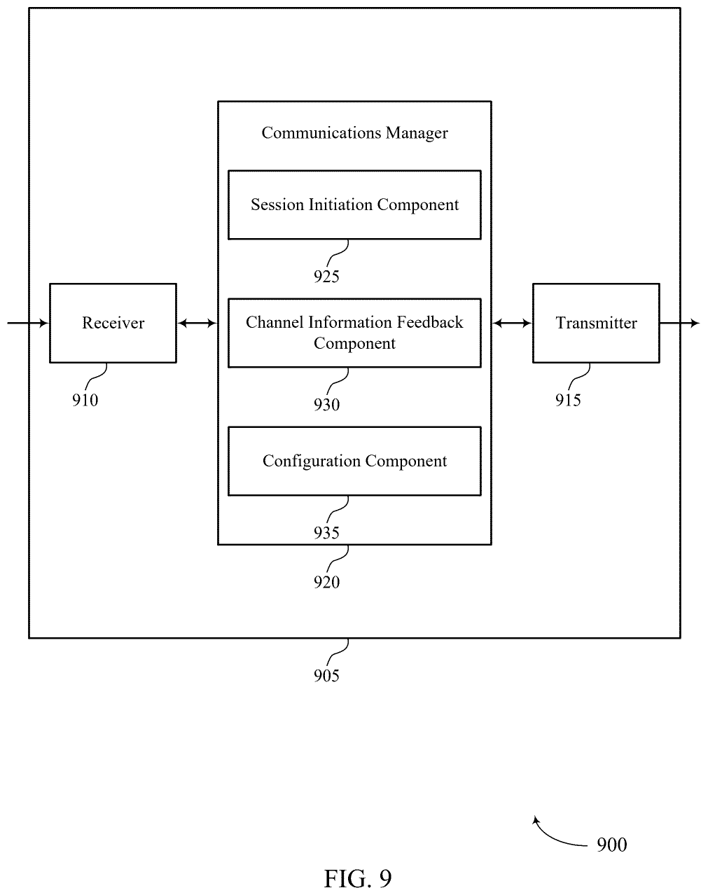

FIG. 9 shows a block diagram 900 of a device 905 that supports techniques for conveying channel information to a network entity during SDT operations in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for conveying channel information to a network entity during SDT operations as described herein. For example, the communications manager 920 may include a session initiation component 925, a channel information feedback component 930, a configuration component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The session initiation component 925 is capable of, configured to, or operable to support a means for initiating a transmission session with a user equipment based on a size of an uplink payload being less than a threshold size and based on an initial channel quality associated with a communication link between the UE and the network entity satisfying a threshold channel quality. The channel information feedback component 930 is capable of, configured to, or operable to support a means for receiving, during the transmission session while the UE is in an inactive mode, an uplink message indicative of current channel information associated with the UE. The configuration component 935 is capable of, configured to, or operable to support a means for transmitting a control message indicative of one or more communication parameters associated with the UE based on receiving the uplink message indicative of the current channel information associated with the UE.

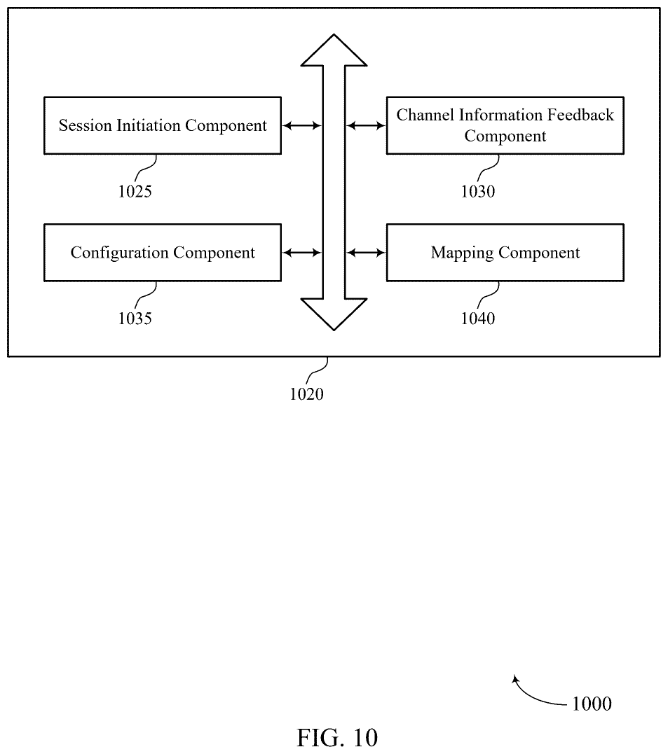

FIG. 10 shows a block diagram 1000 of a communications manager 1020 that supports techniques for conveying channel information to a network entity during SDT operations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for conveying channel information to a network entity during SDT operations as described herein. For example, the communications manager 1020 may include a session initiation component 1025, a channel information feedback component 1030, a configuration component 1035, a mapping component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The session initiation component 1025 is capable of, configured to, or operable to support a means for initiating a transmission session with a user equipment based on a size of an uplink payload being less than a threshold size and based on an initial channel quality associated with a communication link between the UE and the network entity satisfying a threshold channel quality. The channel information feedback component 1030 is capable of, configured to, or operable to support a means for receiving, during the transmission session while the UE is in an inactive mode, an uplink message indicative of current channel information associated with the UE. The configuration component 1035 is capable of, configured to, or operable to support a means for transmitting a control message indicative of one or more communication parameters associated with the UE based on receiving the uplink message indicative of the current channel information associated with the UE.

In some examples, the one or more communication parameters may be based on the current channel information associated with the UE.

In some examples, to support receiving the uplink message indicative of the current channel information associated with the UE, the channel information feedback component 1030 is capable of, configured to, or operable to support a means for receiving, during an establishment portion of the transmission session, an indication of the initial channel quality associated with the communication link between the UE and the network entity, where the current channel information includes the initial channel quality.

In some examples, the initial channel quality is indicated via a differential value with respect to the threshold channel quality.

In some examples, the uplink message is a third uplink message of a four step RA procedure. In some examples, the establishment portion of the transmission session includes the four step RA procedure.

In some examples, to support receiving the uplink message indicative of the current channel information associated with the UE, the channel information feedback component 1030 is capable of, configured to, or operable to support a means for receiving, during an establishment portion of the transmission session, the uplink message including an indication of whether the initial channel quality associated with the communication link between the UE and the network entity is within a threshold deviation of a previous channel quality associated with a previous transmission session or reported during a connected mode, where the current channel information includes the indication.

In some examples, to support receiving, the uplink message, the channel information feedback component 1030 is capable of, configured to, or operable to support a means for receiving the uplink message including the indication that the initial channel quality is within the threshold of the previous channel quality based on the initial channel quality being within the threshold deviation of the previous channel quality.

In some examples, the configuration component 1035 is capable of, configured to, or operable to support a means for transmitting a second control message indicative of the threshold deviation.

In some examples, to support receiving, the uplink message, the channel information feedback component 1030 is capable of, configured to, or operable to support a means for receiving the uplink message including the indication that the initial channel quality is within the threshold of the previous channel quality based on the initial channel quality and the previous channel quality being associated with a same MCS value.

In some examples, the mapping component 1040 is capable of, configured to, or operable to support a means for transmitting a second control message indicative of a set of multiple mappings between a set of multiple MCS values and a set of multiple channel qualities, where the UE determines the initial channel quality and the previous channel quality are associated with the same MCS value based on the set of multiple mappings.

In some examples, to support receiving the indication of whether the initial channel is within the threshold deviation of the previous channel quality, the channel information feedback component 1030 is capable of, configured to, or operable to support a means for receiving, via one or more first fields, the indication that the initial channel quality is within the threshold deviation of the previous channel quality. In some examples, to support receiving the indication of whether the initial channel is within the threshold deviation of the previous channel quality, the channel information feedback component 1030 is capable of, configured to, or operable to support a means for receiving, via one or more second fields different than the one or more first fields, the indication that the initial channel quality is outside of the threshold deviation of the previous channel quality.

In some examples, the one or more first fields are associated with a first set of one or more resources. In some examples, the one or more second fields are associated with a second set of one or more resources.

In some examples, the uplink message is a first uplink message or a third uplink message of a four step RA procedure. In some examples, the establishment portion of the transmission session includes the four step RA procedure.

In some examples, the current channel information associated with the UE includes an indication of a change in channel quality associated with the communication link between the UE and the network entity.

In some examples, the indication of the change in channel quality associated with the communication link between the UE and the network entity includes one or more channel quality metrics configured for the UE in the inactive mode. In some examples, the one or more channel quality metrics are a subset of a set of multiple channel quality metrics configured for the UE in a connected mode.

In some examples, the set of multiple channel quality metrics configured for the UE in the connected mode are associated with a first quantity of bits. In some examples, the one or more channel quality metrics configured for the UE in the inactive mode are associated with a second quantity of bits less than the first quantity of bits.

In some examples, the configuration component 1035 is capable of, configured to, or operable to support a means for transmitting a second control message indicative of a periodicity, a format, or both, associated with the uplink message.

In some examples, the second control message is an RRC message.

In some examples, the one or more communications parameters configured for the UE in the inactive mode are a subset of a set of multiple communication parameters configured for the UE in a connected mode.

In some examples, the set of multiple communication parameters configured for the UE in the connected mode are associated with a first table. In some examples, the one or more communication parameters configured for the UE in the inactive mode are associated with a second table.

In some examples, the uplink message includes an SR or a BSR. In some examples, the uplink message is multiplexed with an uplink control message or an uplink data message.

In some examples, the one or more communication parameters includes an MCS, a waveform, or both.

In some examples, the control message is a DCI message or a MAC-CE message.

In some examples, the transmission session is an SDT session.

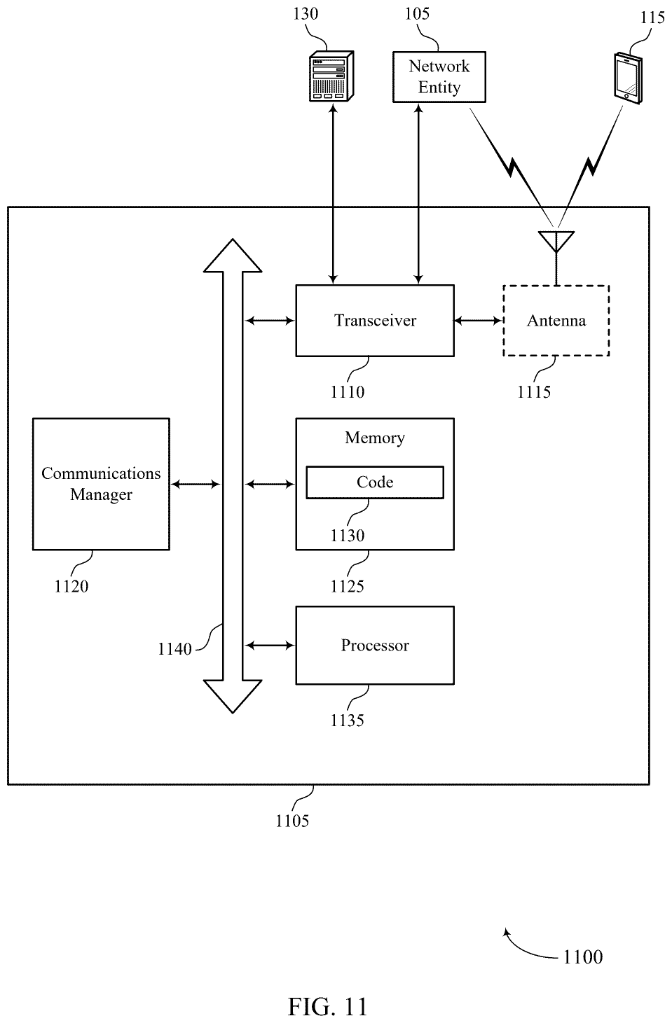

FIG. 11 shows a diagram of a system 1100 including a device 1105 that supports techniques for conveying channel information to a network entity during SDT operations in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for conveying channel information to a network entity during SDT operations). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for initiating a transmission session with a user equipment based on a size of an uplink payload being less than a threshold size and based on an initial channel quality associated with a communication link between the UE and the network entity satisfying a threshold channel quality. The communications manager 1120 is capable of, configured to, or operable to support a means for receiving, during the transmission session while the UE is in an inactive mode, an uplink message indicative of current channel information associated with the UE. The communications manager 1120 is capable of, configured to, or operable to support a means for transmitting a control message indicative of one or more communication parameters associated with the UE based on receiving the uplink message indicative of the current channel information associated with the UE.

By including or configuring the communications manager 1120 in accordance with examples as described herein, the device 1105 may support techniques for conveying channel information to a network entity during SDT operations, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for conveying channel information to a network entity during SDT operations as described herein, or the at least one processor 1135 and the at least one memory 1125 may be otherwise configured to, individually or collectively, perform or support such operations.

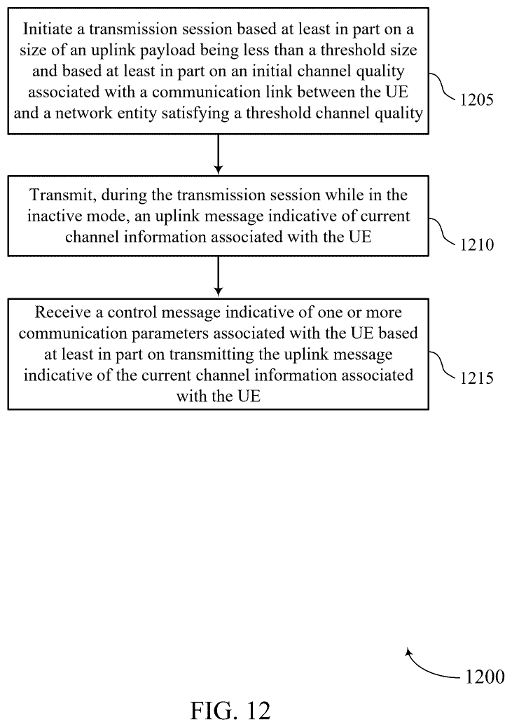

FIG. 12 shows a flowchart illustrating a method 1200 that supports techniques for conveying channel information to a network entity during SDT operations in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include initiating a transmission session based at least in part on a size of an uplink payload being less than a threshold size and based at least in part on an initial channel quality associated with a communication link between the UE and a network entity satisfying a threshold channel quality. The operations of 1205 may be performed in accordance with examples as disclosed herein. In some examples, aspects of the operations of 1205 may be performed by a session initiation component 625 as described with reference to FIG. 6.

At 1210, the method may include transmitting, during the transmission session while in the inactive mode, an uplink message indicative of current channel information associated with the UE. The operations of 1210 may be performed in accordance with examples as disclosed herein. In some examples, aspects of the operations of 1210 may be performed by a channel information reporting component 630 as described with reference to FIG. 6.

At 1215, the method may include receiving a control message indicative of one or more communication parameters associated with the UE based on transmitting the uplink message indicative of the current channel information associated with the UE. The operations of 1215 may be performed in accordance with examples as disclosed herein. In some examples, aspects of the operations of 1215 may be performed by a configuration component 635 as described with reference to FIG. 6.

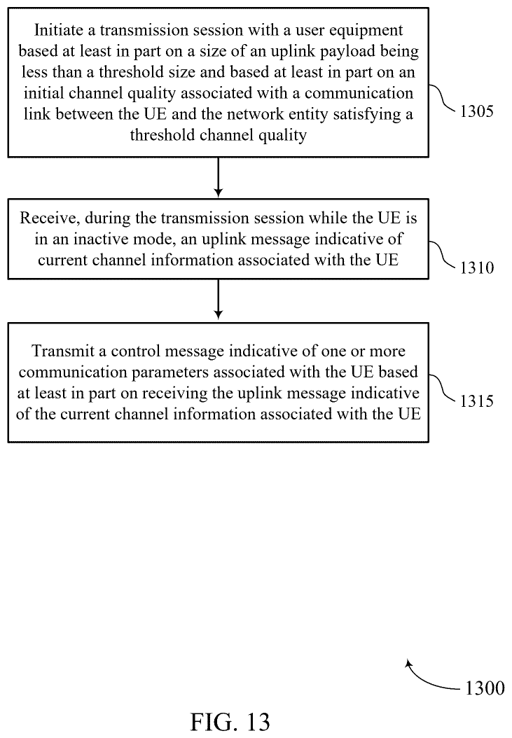

FIG. 13 shows a flowchart illustrating a method 1300 that supports techniques for conveying channel information to a network entity during SDT operations in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include initiating a transmission session with a user equipment based at least in part on a size of an uplink payload being less than a threshold size and based at least in part on an initial channel quality associated with a communication link between the UE and the network entity satisfying a threshold channel quality. The operations of 1305 may be performed in accordance with examples as disclosed herein. In some examples, aspects of the operations of 1305 may be performed by a session initiation component 1025 as described with reference to FIG. 10.

At 1310, the method may include receiving, during the transmission session while the UE is in an inactive mode, an uplink message indicative of current channel information associated with the UE. The operations of 1310 may be performed in accordance with examples as disclosed herein. In some examples, aspects of the operations of 1310 may be performed by a channel information feedback component 1030 as described with reference to FIG. 10.

At 1315, the method may include transmitting a control message indicative of one or more communication parameters associated with the UE based on receiving the uplink message indicative of the current channel information associated with the UE. The operations of 1315 may be performed in accordance with examples as disclosed herein. In some examples, aspects of the operations of 1315 may be performed by a configuration component 1035 as described with reference to FIG. 10.

The following provides an overview of aspects of the present disclosure:

Aspect 1: A method for wireless communications at a UE in an inactive mode, comprising: initiating a transmission session based at least in part on a size of an uplink payload being less than a threshold size and based at least in part on an initial channel quality associated with a communication link between the UE and a network entity satisfying a threshold channel quality; transmitting, during the transmission session while in the inactive mode, an uplink message indicative of current channel information associated with the UE; and receiving a control message indicative of one or more communication parameters associated with the UE based at least in part on transmitting the uplink message indicative of the current channel information associated with the UE.

Aspect 2: The method of aspect 1, wherein the one or more communication parameters are based at least in part on the current channel information associated with the UE.

Aspect 3: The method of any of aspects 1 through 2, wherein transmitting the uplink message indicative of the current channel information associated with the UE comprises: transmitting, during an establishment portion of the transmission session, an indication of the initial channel quality associated with the communication link between the UE and the network entity, wherein the current channel information comprises the initial channel quality.

Aspect 4: The method of aspect 3, wherein transmitting the indication of the initial channel quality comprises: transmitting a differential value with respect to the threshold channel quality to indicate the initial channel quality.

Aspect 5: The method of any of aspects 3 through 4, wherein the uplink message is a third uplink message of a four step RA procedure, and the establishment portion of the transmission session comprises the four step RA procedure.

Aspect 6: The method of any of aspects 1 through 5, wherein transmitting the uplink message indicative of the current channel information associated with the UE comprises: transmitting, during an establishment portion of the transmission session, the uplink message comprising an indication of whether the initial channel quality associated with the communication link between the UE and the network entity is within a threshold deviation of a previous channel quality associated with a previous transmission session or reported during a connected mode, wherein the current channel information comprises the indication.

Aspect 7: The method of aspect 6, wherein transmitting the uplink message comprises: transmitting the uplink message comprising the indication that the initial channel quality is within the threshold of the previous channel quality based at least in part on the initial channel quality being within the threshold deviation of the previous channel quality.

Aspect 8: The method of aspect 7, further comprising: receiving a second control message indicative of the threshold deviation.

Aspect 9: The method of any of aspects 6 through 8, wherein transmitting the uplink message comprises: transmitting the uplink message comprising the indication that the initial channel quality is within the threshold of the previous channel quality based at least in part on the initial channel quality and the previous channel quality being associated with a same MCS value.

Aspect 10: The method of aspect 9, further comprising: receiving a second control message indicative of a plurality of mappings between a plurality of MCS values and a plurality of channel qualities, wherein the UE determines the initial channel quality and the previous channel quality are associated with the same MCS value based at least in part on the plurality of mappings.

Aspect 11: The method of any of aspects 9 through 10, wherein the UE is preconfigured with a plurality of mappings between a plurality of MCS values and a plurality of channel qualities, and the UE determines the initial channel quality and the previous channel quality are associated with the same MCS value based at least in part on the plurality of mappings.

Aspect 12: The method of any of aspects 6 through 11, wherein transmitting the indication of whether the initial channel is within the threshold deviation of the previous channel quality comprises: transmitting, via one or more first fields, the indication that the initial channel quality is within the threshold deviation of the previous channel quality; or transmitting, via one or more second fields different than the one or more first fields, the indication that the initial channel quality is outside of the threshold deviation of the previous channel quality.

Aspect 13: The method of aspect 12, wherein the one or more first fields are associated with a first set of one or more resources, and the one or more second fields are associated with a second set of one or more resources.

Aspect 14: The method of any of aspects 6 through 13, wherein the uplink message is a first uplink message or a third uplink message of a four step RA procedure, and the establishment portion of the transmission session comprises the four step RA procedure.

Aspect 15: The method of any of aspects 1 through 14, wherein the current channel information associated with the UE comprises an indication of a change in channel quality associated with the communication link between the UE and the network entity.

Aspect 16: The method of aspect 15, wherein the indication of the change in channel quality associated with the communication link between the UE and the network entity comprises one or more channel quality metrics supported by the UE in the inactive mode, and the one or more channel quality metrics are a subset of a plurality of channel quality metrics supported by the UE in a connected mode.

Aspect 17: The method of aspect 16, wherein the plurality of channel quality metrics supported by the UE in the connected mode are associated with a first quantity of bits, and the one or more channel quality metrics supported by the UE in the inactive mode are associated with a second quantity of bits less than the first quantity of bits.

Aspect 18: The method of any of aspects 15 through 17, further comprising: receiving a second control message indicative of a periodicity, a format, or both, associated with the uplink message.

Aspect 19: The method of aspect 18, wherein the second control message is a RRC message.

Aspect 20: The method of any of aspects 15 through 19, wherein the one or more communications parameters supported by the UE in the inactive mode are a subset of a plurality of communication parameters supported by the UE in a connected mode.

Aspect 21: The method of aspect 20, wherein the plurality of communication parameters supported by the UE in the connected mode are associated with a first table, and the one or more communication parameters supported by the UE in the inactive mode are associated with a second table.

Aspect 22: The method of any of aspects 15 through 21, wherein the uplink message comprises an SR or a BFR, and the uplink message is multiplexed with an uplink control message or an uplink data message.

Aspect 23: The method of any of aspects 1 through 22, wherein the one or more communication parameters comprises an MCS, a waveform, or both.

Aspect 24: The method of any of aspects 1 through 23, wherein the control message is a downlink control information message or a medium access control-control element message.

Aspect 25: The method of any of aspects 1 through 24, wherein the transmission session is an SDT session.

Aspect 26: A method for wireless communications at a network entity, comprising: initiating a transmission session with a user equipment based at least in part on a size of an uplink payload being less than a threshold size and based at least in part on an initial channel quality associated with a communication link between the UE and the network entity satisfying a threshold channel quality; receiving, during the transmission session while the UE is in an inactive mode, an uplink message indicative of current channel information associated with the UE; and transmitting a control message indicative of one or more communication parameters associated with the UE based at least in part on receiving the uplink message indicative of the current channel information associated with the UE.

Aspect 27: The method of aspect 26, wherein the one or more communication parameters are based at least in part on the current channel information associated with the UE.

Aspect 28: The method of any of aspects 26 through 27, wherein receiving the uplink message indicative of the current channel information associated with the UE comprises: receiving, during an establishment portion of the transmission session, an indication of the initial channel quality associated with the communication link between the UE and the network entity, wherein the current channel information comprises the initial channel quality.

Aspect 29: The method of aspect 28, wherein the initial channel quality is indicated via a differential value with respect to the threshold channel quality.

Aspect 30: The method of any of aspects 28 through 29, wherein the uplink message is a third uplink message of a four step RA procedure, and the establishment portion of the transmission session comprises the four step RA procedure.

Aspect 31: The method of any of aspects 26 through 30, wherein receiving the uplink message indicative of the current channel information associated with the UE comprises: receiving, during an establishment portion of the transmission session, the uplink message comprising an indication of whether the initial channel quality associated with the communication link between the UE and the network entity is within a threshold deviation of a previous channel quality associated with a previous transmission session or reported during a connected mode, wherein the current channel information comprises the indication.

Aspect 32: The method of aspect 31, wherein receiving, the uplink message comprises: receiving the uplink message comprising the indication that the initial channel quality is within the threshold of the previous channel quality based at least in part on the initial channel quality being within the threshold deviation of the previous channel quality.

Aspect 33: The method of aspect 32, further comprising: transmitting a second control message indicative of the threshold deviation.

Aspect 34: The method of any of aspects 31 through 33, wherein receiving, the uplink message comprises: receiving the uplink message comprising the indication that the initial channel quality is within the threshold of the previous channel quality based at least in part on the initial channel quality and the previous channel quality being associated with a same MCS value.

Aspect 35: The method of aspect 34, further comprising: transmitting a second control message indicative of a plurality of mappings between a plurality of MCS values and a plurality of channel qualities, wherein the UE determines the initial channel quality and the previous channel quality are associated with the same MCS value based at least in part on the plurality of mappings.

Aspect 36: The method of any of aspects 31 through 35, wherein receiving the indication of whether the initial channel is within the threshold deviation of the previous channel quality comprises: receiving, via one or more first fields, the indication that the initial channel quality is within the threshold deviation of the previous channel quality; or receiving, via one or more second fields different than the one or more first fields, the indication that the initial channel quality is outside of the threshold deviation of the previous channel quality.

Aspect 37: The method of aspect 36, wherein the one or more first fields are associated with a first set of one or more resources, and the one or more second fields are associated with a second set of one or more resources.

Aspect 38: The method of any of aspects 31 through 37, wherein the uplink message is a first uplink message or a third uplink message of a four step RA procedure, and the establishment portion of the transmission session comprises the four step RA procedure.

Aspect 39: The method of any of aspects 26 through 38, wherein the current channel information associated with the UE comprises an indication of a change in channel quality associated with the communication link between the UE and the network entity.

Aspect 40: The method of aspect 39, wherein the indication of the change in channel quality associated with the communication link between the UE and the network entity comprises one or more channel quality metrics configured for the UE in the inactive mode, and the one or more channel quality metrics are a subset of a plurality of channel quality metrics configured for the UE in a connected mode.

Aspect 41: The method of aspect 40, wherein the plurality of channel quality metrics configured for the UE in the connected mode are associated with a first quantity of bits, and the one or more channel quality metrics configured for the UE in the inactive mode are associated with a second quantity of bits less than the first quantity of bits.

Aspect 42: The method of any of aspects 39 through 41, further comprising: transmitting a second control message indicative of a periodicity, a format, or both, associated with the uplink message.

Aspect 43: The method of aspect 42, wherein the second control message is a RRC message.

Aspect 44: The method of any of aspects 39 through 43, wherein the one or more communications parameters configured for the UE in the inactive mode are a subset of a plurality of communication parameters configured for the UE in a connected mode.

Aspect 45: The method of aspect 44, wherein the plurality of communication parameters configured for the UE in the connected mode are associated with a first table, and the one or more communication parameters configured for the UE in the inactive mode are associated with a second table.

Aspect 46: The method of any of aspects 39 through 45, wherein the uplink message comprises an SR or a BFR, and the uplink message is multiplexed with an uplink control message or an uplink data message.

Aspect 47: The method of any of aspects 26 through 46, wherein the one or more communication parameters comprises an MCS, a waveform, or both.

Aspect 48: The method of any of aspects 26 through 47, wherein the control message is a downlink control information message or a medium access control-control element message.

Aspect 49: The method of any of aspects 26 through 48, wherein the transmission session is an SDT session.

Aspect 50: An apparatus for wireless communications at a UE in an inactive mode, comprising one or more memories storing processor-executable code, and one or more processors coupled with the one or more memories and individually or collectively operable to execute the code to cause the apparatus to perform a method of any of aspects 1 through 25.

Aspect 51: An apparatus for wireless communications at a UE in an inactive mode, comprising at least one means for performing a method of any of aspects 1 through 25.

Aspect 52: A non-transitory computer-readable medium storing code for wireless communications at a UE in an inactive mode, the code comprising instructions executable by one or more processors to perform a method of any of aspects 1 through 25.

Aspect 53: A network entity for wireless communications, comprising one or more memories storing processor-executable code, and one or more processors coupled with the one or more memories and individually or collectively operable to execute the code to cause the network entity to perform a method of any of aspects 26 through 49.

Aspect 54: A network entity for wireless communications, comprising at least one means for performing a method of any of aspects 26 through 49.

Aspect 55: A non-transitory computer-readable medium storing code for wireless communications, the code comprising instructions executable by one or more processors to perform a method of any of aspects 26 through 49.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) in an inactive mode, comprising:
one or more memories storing processor-executable code; and
one or more processors coupled with the one or more memories and individually or collectively operable to execute the code to cause the UE to:
initiate a transmission session based at least in part on a size of an uplink payload being less than a threshold size and based at least in part on an initial channel quality associated with a communication link between the UE and a network entity satisfying a threshold channel quality;
transmit, during the transmission session while in the inactive mode, an uplink message indicative of current channel information associated with the UE; and
receive a control message indicative of one or more communication parameters associated with the UE based at least in part on transmitting the uplink message indicative of the current channel information associated with the UE.

2. The UE of claim 1, wherein the one or more communication parameters are based at least in part on the current channel information associated with the UE.

3. The UE of claim 1, wherein, to transmit the uplink message indicative of the current channel information associated with the UE, the one or more processors are individually or collectively operable to execute the code to cause the UE to:
transmit, during an establishment portion of the transmission session, an indication of the initial channel quality associated with the communication link between the UE and the network entity, wherein the current channel information comprises the initial channel quality.

4. The UE of claim 3, wherein, to transmit the indication of the initial channel quality, the one or more processors are individually or collectively operable to execute the code to cause the UE to:
transmit a differential value with respect to the threshold channel quality to indicate the initial channel quality.

5. The UE of claim 3, wherein the uplink message is a third uplink message of a four step random access procedure, and wherein the establishment portion of the transmission session comprises the four step random access procedure.

6. The UE of claim 1, wherein, to transmit the uplink message indicative of the current channel information associated with the UE, the one or more processors are individually or collectively operable to execute the code to cause the UE to:
transmit, during an establishment portion of the transmission session, the uplink message comprising an indication of whether the initial channel quality associated with the communication link between the UE and the network entity is within a threshold deviation of a previous channel quality associated with a previous transmission session or reported during a connected mode, wherein the current channel information comprises the indication.

7. The UE of claim 6, wherein, to transmit the uplink message, the one or more processors are individually or collectively operable to execute the code to cause the UE to:
transmit the uplink message comprising the indication that the initial channel quality is within the threshold deviation of the previous channel quality based at least in part on the initial channel quality being within the threshold deviation of the previous channel quality.

8. The UE of claim 7, wherein the one or more processors are individually or collectively further operable to execute the code to cause the UE to:
receive a second control message indicative of the threshold deviation.

9. The UE of claim 6, wherein, to transmit the uplink message, the one or more processors are individually or collectively operable to execute the code to cause the UE to:
transmit the uplink message comprising the indication that the initial channel quality is within the threshold deviation of the previous channel quality based at least in part on the initial channel quality and the previous channel quality being associated with a same modulation and coding scheme value.

10. The UE of claim 9, wherein the one or more processors are individually or collectively further operable to execute the code to cause the UE to:
receive a second control message indicative of a plurality of mappings between a plurality of modulation and coding scheme values and a plurality of channel qualities, wherein the UE determines the initial channel quality and the previous channel quality are associated with the same modulation and coding scheme value based at least in part on the plurality of mappings.

11. The UE of claim 9, wherein the UE is preconfigured with a plurality of mappings between a plurality of modulation and coding scheme values and a plurality of channel qualities, and wherein the UE determines the initial channel quality and the previous channel quality are associated with the same modulation and coding scheme value based at least in part on the plurality of mappings.

12. The UE of claim 6, wherein, to transmit the indication of whether the initial channel quality is within the threshold deviation of the previous channel quality, the one or more processors are individually or collectively operable to execute the code to cause the UE to:
transmit, via one or more first fields, the indication that the initial channel quality is within the threshold deviation of the previous channel quality; or
transmit, via one or more second fields different than the one or more first fields, the indication that the initial channel quality is outside of the threshold deviation of the previous channel quality.

13. The UE of claim 6, wherein the uplink message is a first uplink message or a third uplink message of a four step random access procedure, and wherein the establishment portion of the transmission session comprises the four step random access procedure.

14. The UE of claim 1, wherein the current channel information associated with the UE comprises an indication of a change in channel quality associated with the communication link between the UE and the network entity.

15. The UE of claim 14, wherein the indication of the change in channel quality associated with the communication link between the UE and the network entity comprises one or more channel quality metrics supported by the UE in the inactive mode, and wherein the one or more channel quality metrics are a subset of a plurality of channel quality metrics supported by the UE in a connected mode.

16. The UE of claim 14, wherein the one or more processors are individually or collectively further operable to execute the code to cause the UE to:
receive a second control message indicative of a periodicity, a format, or both, associated with the uplink message.

17. The UE of claim 14, wherein one or more communications parameters supported by the UE in the inactive mode are a subset of a plurality of communication parameters supported by the UE in a connected mode.

18. The UE of claim 14, wherein the uplink message comprises a scheduling request or a buffer status report, and wherein the uplink message is multiplexed with an uplink control message or an uplink data message.

19. A method for wireless communications at a user equipment (UE) in an inactive mode, comprising:
initiating a transmission session based at least in part on a size of an uplink payload being less than a threshold size and based at least in part on an initial channel quality associated with a communication link between the UE and a network entity satisfying a threshold channel quality;
transmitting, during the transmission session while in the inactive mode, an uplink message indicative of current channel information associated with the UE; and
receiving a control message indicative of one or more communication parameters associated with the UE based at least in part on transmitting the uplink message indicative of the current channel information associated with the UE.

20. An apparatus for wireless communications at a user equipment (UE) in an inactive mode, comprising:
means for initiating a transmission session based at least in part on a size of an uplink payload being less than a threshold size and based at least in part on an initial channel quality associated with a communication link between the UE and a network entity satisfying a threshold channel quality;
means for transmitting, during the transmission session while in the inactive mode, an uplink message indicative of current channel information associated with the UE; and
means for receiving a control message indicative of one or more communication parameters associated with the UE based at least in part on transmitting the uplink message indicative of the current channel information associated with the UE.
